(19) United States
(12) Patent Application Publication
(10) Pub. No.: US 2024/0098315 A1
(43) Pub. Date: Mar. 21, 2024

(54) KEYWORD-BASED OBJECT INSERTION INTO A VIDEO STREAM

(71) Applicant: QUALCOMM Incorporated, San Diego, CA (US)

(72) Inventors: Sandeep Sethia, Bengaluru (IN); Tanmay Agarwal, Najibabad (IN); Ravichandra Ponaganti, Hyderabad (IN)

(21) Appl. No.: 17/933,425

(22) Filed: Sep. 19, 2022

(51) Int. Cl. H04N 21/234; G10L 15/16; H04N 21/8405

(52) U.S. Cl. CPC H04N 21/23424; G10L 15/16; H04N 21/8405; G10L 2015/088

(57) ABSTRACT

A device includes one or more processors configured to obtain an audio stream and to detect one or more keywords in the audio stream. The one or more processors are also configured to adaptively classify one or more objects associated with the one or more keywords. The one or more processors are further configured to insert the one or more objects into a video stream.

### I. FIELD

The present disclosure is generally related to inserting one or more objects in a video stream based on one or more keywords.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to receive audio captured by microphones and to play out the audio via speakers. The devices often also incorporate functionality to display video captured by cameras. In some examples, devices incorporate functionality to receive a media stream and play out the audio of the media stream via speakers concurrently with displaying the video of the media stream. With a live media stream that is being displayed concurrently with receipt or capture, there is typically not enough time for a user to edit the video prior to display. Thus, enhancements that could otherwise be made to improve audience retention, to add related content, etc. are not available when presenting a live media stream, which can result in a reduced viewer experience.

### III. SUMMARY

According to one implementation of the present disclosure, a device includes one or more processors configured to obtain an audio stream and to detect one or more keywords in the audio stream. The one or more processors are also configured to adaptively classify one or more objects associated with the one or more keywords. The one or more processors are further configured to insert the one or more objects into a video stream.

According to another implementation of the present disclosure, a method includes obtaining an audio stream at a device. The method also includes detecting, at the device, one or more keywords in the audio stream. The method further includes adaptively classifying, at the device, one or more objects associated with the one or more keywords. The method also includes inserting, at the device, the one or more objects into a video stream.

According to another implementation of the present disclosure, a non-transitory computer-readable medium includes instructions that, when executed by one or more processors, cause the one or more processors to obtain an audio stream and to detect one or more keywords in the audio stream. The instructions, when executed by the one or more processors, also cause the one or more processors to adaptively classify one or more objects associated with the one or more keywords. The instructions, when executed by the one or more processors, further cause the one or more processors to insert the one or more objects into a video stream.

According to another implementation of the present disclosure, an apparatus includes means for obtaining an audio stream. The apparatus also includes means for detecting one or more keywords in the audio stream. The apparatus further includes means for adaptively classifying one or more objects associated with the one or more keywords. The apparatus also includes means for inserting the one or more objects into a video stream.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform keyword-based object insertion into a video stream and illustrative examples of keyword-based object insertion into a video stream, in accordance with some examples of the present disclosure.

FIG. 2 is a diagram of a particular implementation of a method of keyword-based object insertion into a video stream and an illustrative example of keyword-based object insertion into a video stream that may be performed by the device of FIG. 1, in accordance with some examples of the present disclosure.

FIG. 3 is a diagram of another particular implementation of a method of keyword-based object insertion into a video stream and a diagram of illustrative examples of keyword-based object insertion into a video stream that may be performed by the device of FIG. 1, in accordance with some examples of the present disclosure.

FIG. 4 is a diagram of an illustrative aspect of an example of a keyword detection unit of the system of FIG. 1, in accordance with some examples of the present disclosure.

FIG. 5 is a diagram of an illustrative aspect of operations associated with keyword detection, in accordance with some examples of the present disclosure.

FIG. 6 is a diagram of another particular implementation of a method of object generation and illustrative examples of object generation that may be performed by the device of FIG. 1, in accordance with some examples of the present disclosure.

FIG. 7 is a diagram of an illustrative aspect of an example of one or more components of an object determination unit of the system of FIG. 1, in accordance with some examples of the present disclosure.

FIG. 8 is a diagram of an illustrative aspect of operations associated with object classification, in accordance with some examples of the present disclosure.

FIG. 9A is a diagram of another illustrative aspect of operations associated with an object classification neural network of the system of FIG. 1, in accordance with some examples of the present disclosure.

FIG. 9B is a diagram of an illustrative aspect of operations associated with feature extraction performed by the object classification neural network of the system of FIG. 1, in accordance with some examples of the present disclosure.

FIG. 9C is a diagram of an illustrative aspect of operations associated with classification and probability distribution performed by the object classification neural network of the system of FIG. 1, in accordance with some examples of the present disclosure.

FIG. 10A is a diagram of a particular implementation of a method of insertion location determination that may be performed by the device of FIG. 1 and an example of determining an insertion location, in accordance with some examples of the present disclosure.

FIG. 10B is a diagram of an illustrative aspect of operations performed by a location neural network of the system of FIG. 1, in accordance with some examples of the present disclosure.

FIG. 11 is a block diagram of an illustrative aspect of a system operable to perform keyword-based object insertion into a video stream, in accordance with some examples of the present disclosure.

FIG. 12 is a block diagram of another illustrative aspect of a system operable to perform keyword-based object insertion into a video stream, in accordance with some examples of the present disclosure.

FIG. 13 is a block diagram of another illustrative aspect of a system operable to perform keyword-based object insertion into a video stream, in accordance with some examples of the present disclosure.

FIG. 14 is a block diagram of another illustrative aspect of a system operable to perform keyword-based object insertion into a video stream, in accordance with some examples of the present disclosure.

FIG. 15 is a block diagram of another illustrative aspect of a system operable to perform keyword-based object insertion into a video stream, in accordance with some examples of the present disclosure.

FIG. 16 is a diagram of an illustrative aspect of operation of components of the system of FIG. 1, in accordance with some examples of the present disclosure.

FIG. 17 illustrates an example of an integrated circuit operable to perform keyword-based object insertion into a video stream, in accordance with some examples of the present disclosure.

FIG. 18 is a diagram of a mobile device operable to perform keyword-based object insertion into a video stream, in accordance with some examples of the present disclosure.

FIG. 19 is a diagram of a headset operable to perform keyword-based object insertion into a video stream, in accordance with some examples of the present disclosure.

FIG. 20 is a diagram of a wearable electronic device operable to perform keyword-based object insertion into a video stream, in accordance with some examples of the present disclosure.

FIG. 21 is a diagram of a voice-controlled speaker system operable to perform keyword-based object insertion into a video stream, in accordance with some examples of the present disclosure.

FIG. 22 is a diagram of a camera operable to perform keyword-based object insertion into a video stream, in accordance with some examples of the present disclosure.

FIG. 23 is a diagram of a headset, such as an extended reality headset, operable to perform keyword-based object insertion into a video stream, in accordance with some examples of the present disclosure.

FIG. 24 is a diagram of an extended reality glasses device that is operable to perform keyword-based object insertion into a video stream, in accordance with some examples of the present disclosure.

FIG. 25 is a diagram of a first example of a vehicle operable to perform keyword-based object insertion into a video stream, in accordance with some examples of the present disclosure.

FIG. 26 is a diagram of a second example of a vehicle operable to perform keyword-based object insertion into a video stream, in accordance with some examples of the present disclosure.

FIG. 27 is diagram of a particular implementation of a method of keyword-based object insertion into a video stream that may be performed by the device of FIG. 1, in accordance with some examples of the present disclosure.

FIG. 28 is a block diagram of a particular illustrative example of a device that is operable to perform keyword-based object insertion into a video stream, in accordance with some examples of the present disclosure.

### V. DETAILED DESCRIPTION

Computing devices often incorporate functionality to playback media streams by providing an audio stream to a speaker while concurrently displaying a video stream. With a live media stream that is being displayed concurrently with receipt or capture, there is typically not enough time for a user to perform enhancements to improve audience retention, add related content, etc. to the video stream prior to display.

Systems and methods of performing keyword-based object insertion into a video stream are disclosed. For example, a video stream updater performs keyword detection in an audio stream to generate a keyword, and determines whether a database includes any objects associated with the keyword. The video stream updater, in response to determining that the database includes an object associated with the keyword, inserts the object in the video stream. Alternatively, the video stream updater, in response to determining that the database does not include any object associated with the keyword, applies an object generation neural network to the keyword to generate an object associated with the keyword, and inserts the object in the video stream. Optionally, in some examples, the video stream updater designates the newly generated object as associated with the keyword and adds the object to the database. The video stream updater can thus enhance the video stream using pre-existing objects or newly generated objects that are associated with keywords detected in the audio stream.

The enhancements can improve audience retention, add related content, etc. For example, it can be a challenge to retain interest of an audience during playback of a video stream of a person speaking at a podium. Adding objects to the video stream can make the video stream more interesting to the audience during playback. To illustrate, adding a background image showing the results of planting trees to a live media stream discussing climate change can increase audience retention for the live media stream. As another example, adding an image of a local restaurant to a video stream about traveling to a region that has the same kind of food that is served at the restaurant can entice viewers to visit the local restaurant or can result in increased orders being made to the restaurant. In some examples, enhancements can be made to a video stream based on an audio stream that is obtained separately from the video stream. To illustrate, the video stream can be updated based on user speech included in an audio stream that is received from one or more microphones.

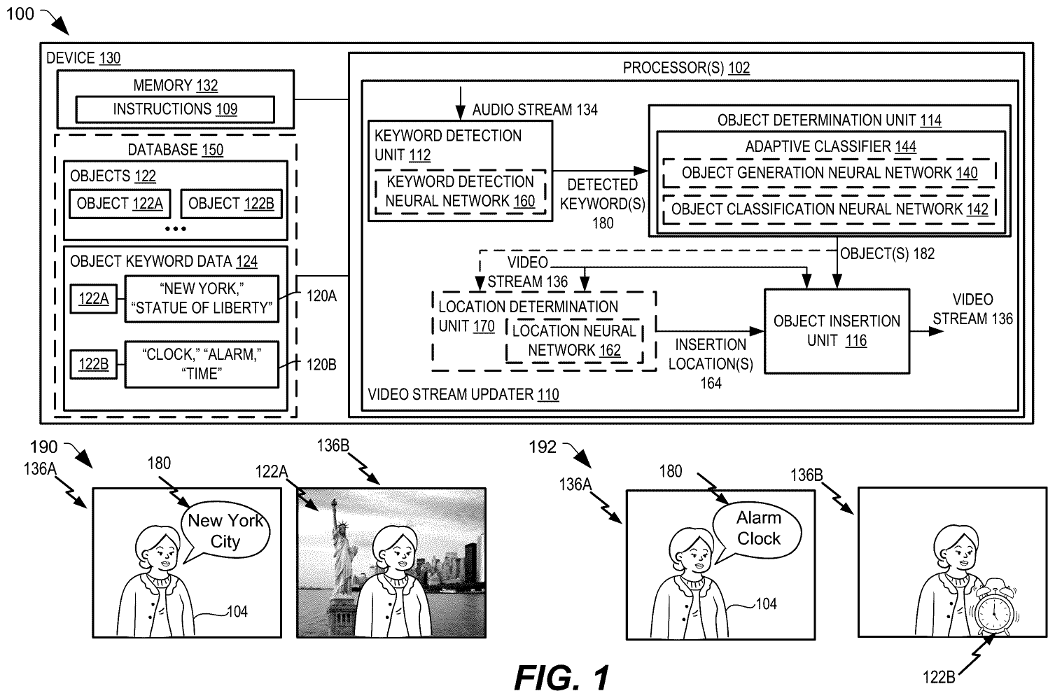

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 130 including one or more processors (“processor(s)” 102 of FIG. 1), which indicates that in some implementations the device 130 includes a single processor 102 and in other implementations the device 130 includes multiple processors 102.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple objects are illustrated and associated with reference numbers 122A and 122B. When referring to a particular one of these objects, such as an object 122A, the distinguishing letter “A” is used. However, when referring to any arbitrary one of these objects or to these objects as a group, the reference number 122 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system 100 is disclosed. The system 100 is configured to perform keyword-based object insertion into a video stream. In FIG. 1, an example 190 and an example 192 of keyword-based object insertion into a video stream are also shown.

The system 100 includes a device 130 that includes one or more processors 102 coupled to a memory 132 and to a database 150. The one or more processors 102 include a video stream updater 110 that is configured to perform keyword-based object insertion in a video stream 136, and the memory 132 is configured to store instructions 109 that are executable by the one or more processors 102 to implement the functionality described with reference to the video stream updater 110.

The video stream updater 110 includes a keyword detection unit 112 coupled, via an object determination unit 114, to an object insertion unit 116. Optionally, in some implementations, the video stream updater 110 also includes a location determination unit 170 coupled to the object insertion unit 116.

The device 130 also includes a database 150 that is accessible to the one or more processors 102. However, in other aspects, the database 150 can be external to the device 130, such as stored in a storage device, a network device, cloud-based storage, or a combination thereof. The database 150 is configured to store a set of objects 122, such as an object 122A, an object 122B, one or more additional objects, or a combination thereof. An “object” as used herein refers to a visual digital element, such as one or more of an image, clip art, a photograph, a drawing, a graphics interchange format (GIF) file, a portable network graphics (PNG) file, or a video clip, as illustrative, non-limiting examples. An “object” is primarily or entirely image-based and is therefore distinct from text-based additions, such as sub-titles.

In some implementations, the database 150 is configured to store object keyword data 124 that indicates one or more keywords 120, if any, that are associated with the one or more objects 122. In a particular example, the object keyword data 124 indicates that an object 122A (e.g., an image of the Statue of Liberty) is associated with one or more keywords 120A (e.g., “New York” and “Statue of Liberty”). In another example, the object keyword data 124 indicates that an object 122B (e.g., clip art representing a clock) is associated with one or more keywords 120B (e.g., “Clock,” “Alarm,” “Time”).

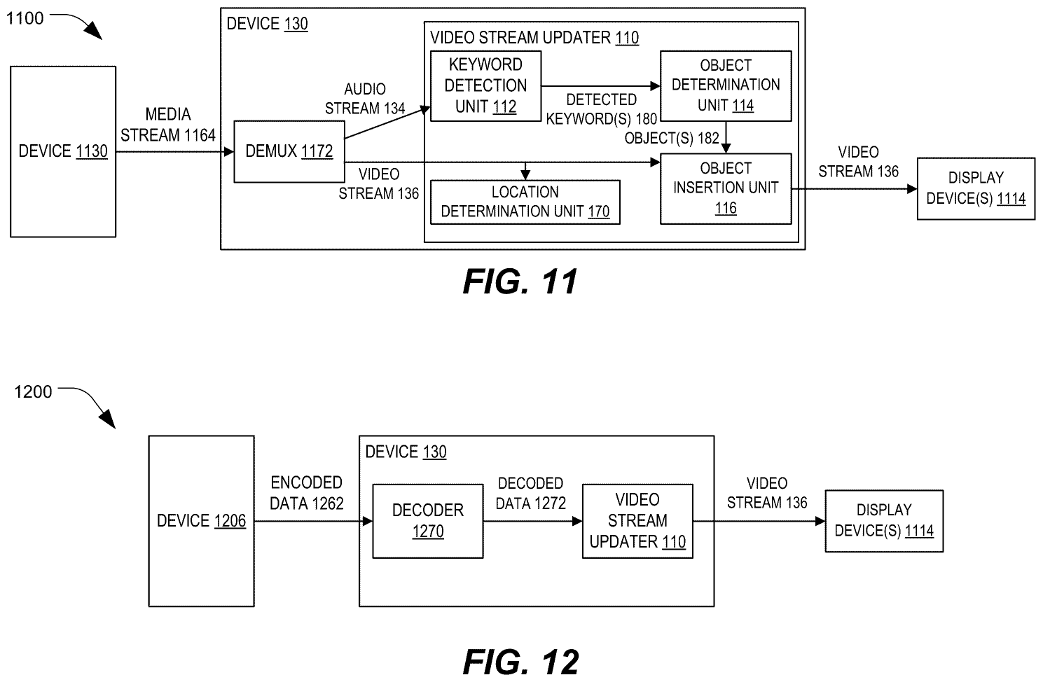

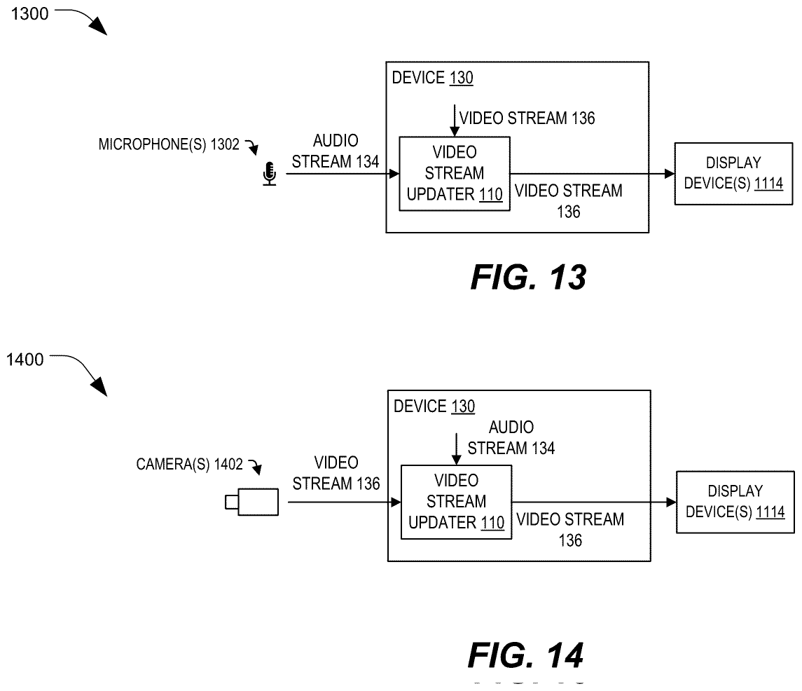

The video stream updater 110 is configured to process an audio stream 134 to detect one or more keywords 180 in the audio stream 134, and insert objects associated with the detected keywords 180 into the video stream 136. In some examples, a media stream (e.g., a live media stream) includes the audio stream 134 and the video stream 136, as further described with reference to FIG. 11. Optionally, in some examples, at least one of the audio stream 134 or the video stream 136 corresponds to decoded data generated by a decoder by decoding encoded data received from another device, as further described with reference to FIG. 12. Optionally, in some examples, the video stream updater 110 is configured to receive the audio stream 134 from one or more microphones coupled to the device 130, as further described with reference to FIG. 13. Optionally, in some examples, the video stream updater 110 is configured to receive the video stream 136 from one or more cameras coupled to the device 130, as further described with reference to FIG. 14. Optionally, in some embodiments, the audio stream 134 is obtained separately from the video stream 136. For example, the audio stream 134 is received from one or more microphones coupled to the device 130 and the video stream 136 is received from another device or generated at the device 130, as further described at least with reference to FIGS. 13, 23, and 26.

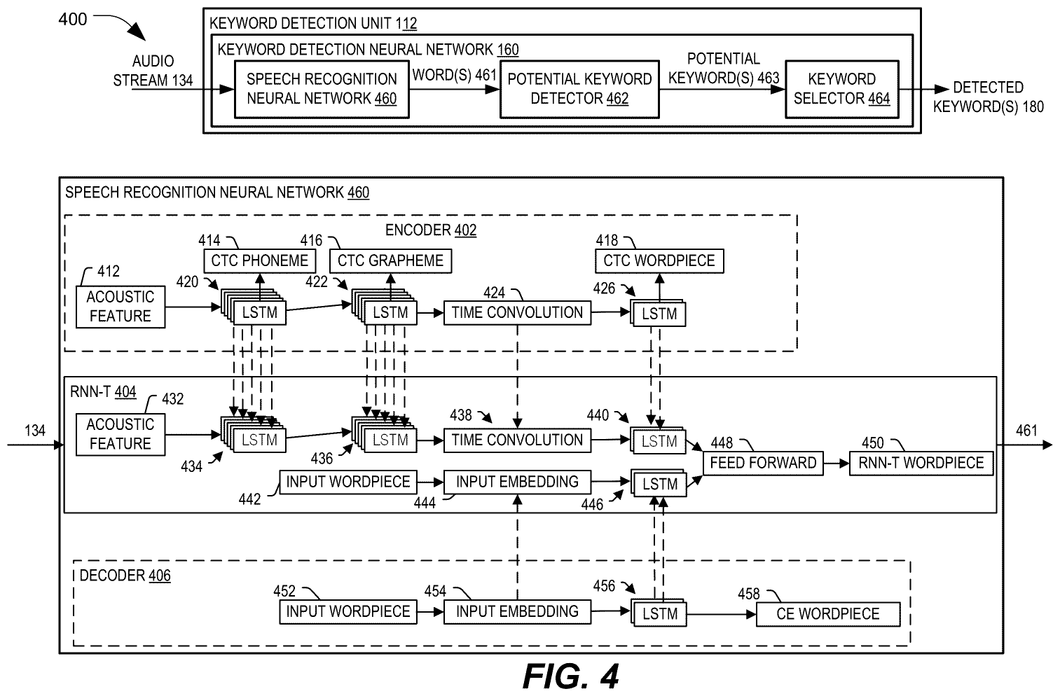

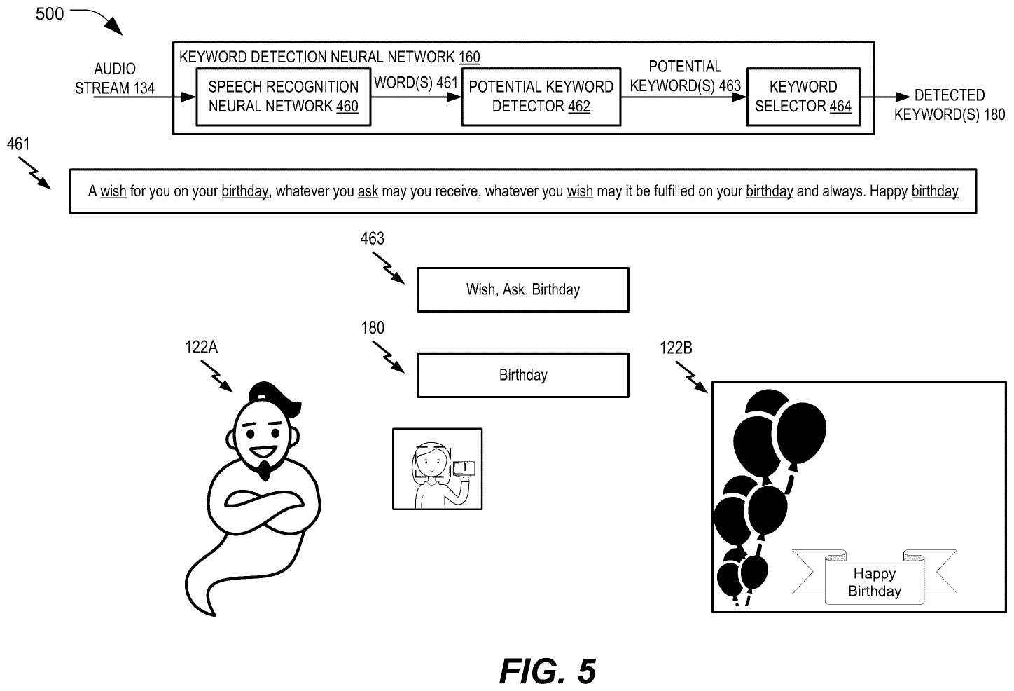

To illustrate, the keyword detection unit 112 is configured to determine one or more detected keywords 180 in at least a portion of the audio stream 134, as further described with reference to FIG. 5. A “keyword” as used herein can refer to a single word or to a phrase including multiple words. In some implementations, the keyword detection unit 112 is configured to apply a keyword detection neural network 160 to at least the portion of the audio stream 134 to generate the one or more detected keywords 180, as further described with reference to FIG. 4.

The object determination unit 114 is configured to determine (e.g., select or generate) one or more objects 182 that are associated with the one or more detected keywords 180. The object determination unit 114 is configured to select, for inclusion into the one or more objects 182, one or more of the objects 122 stored in the database 150 that are indicated by the object keyword data 124 as associated with the one or more detected keywords 180. In a particular aspect, the selected objects correspond to pre-existing and pre-classified objects associated with the one or more detected keywords 180.

The object determination unit 114 includes an adaptive classifier 144 that is configured to adaptively classify the one or more objects 182 associated with the one or more detected keywords 180. Classifying an object 182 includes generating the object 182 based on the one or more detected keywords 180 (e.g., a newly generated object), performing a classification of an object 182 to designate the object 182 as associated with one or more keywords 120 (e.g., a newly classified object) and determining whether any of the keyword(s) 120 match any of the keyword(s) 180, or both. In some aspects, the adaptive classifier 144 is configured to refrain from classifying the object 182 in response to determining that a pre-existing and pre-classified object is associated with at least one of the one or more detected keywords 180. Alternatively, the adaptive classifier 144 is configured to classify (e.g., generate, perform a classification, or both, of) the object 182 in response to determining that none of the pre-existing objects is indicated by the object keyword data 124 as associated with any of the one or more detected keywords 180.

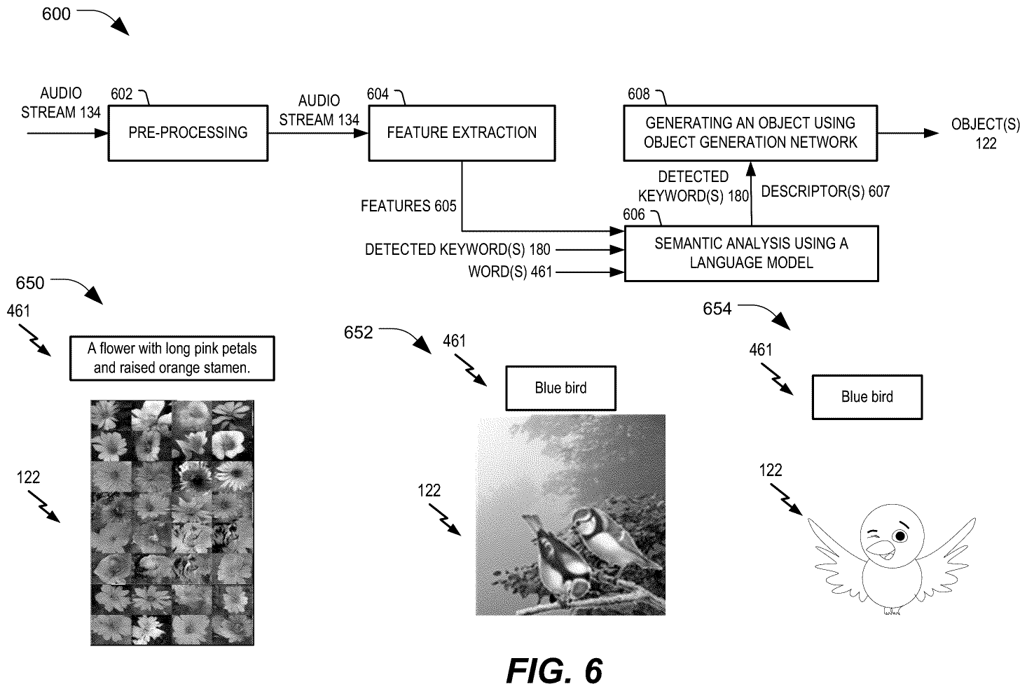

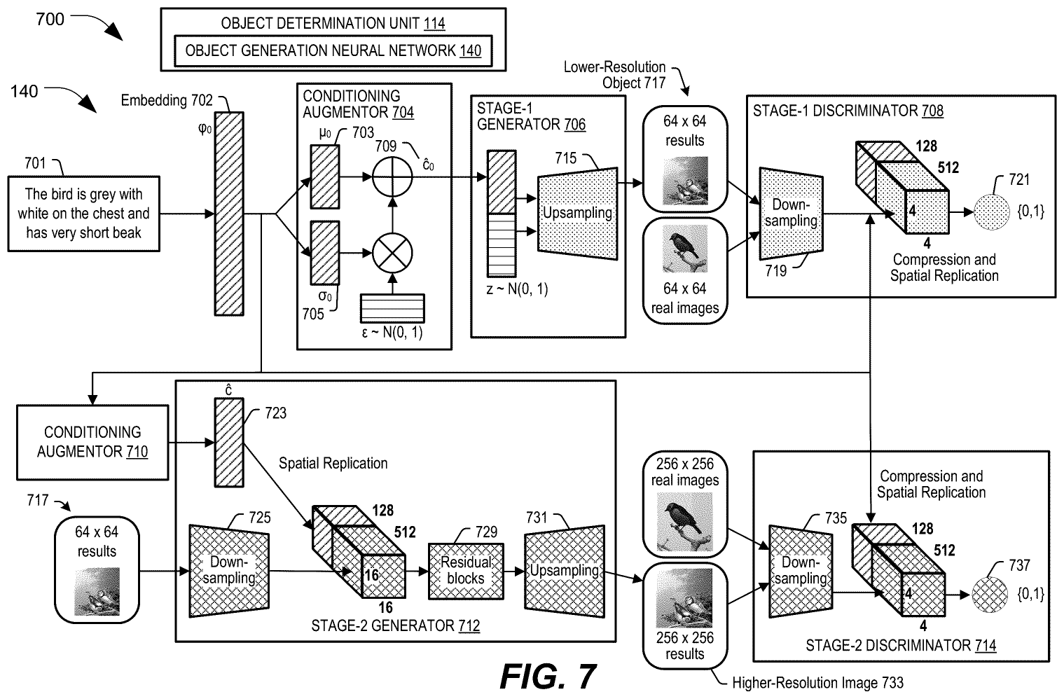

In some aspects, the adaptive classifier 144 includes an object generation neural network 140, an object classification neural network 142, or both. The object generation neural network 140 is configured to generate objects 122 (e.g., newly generated objects) that are associated with the one or more objects 182. For example, the object generation neural network 140 is configured to process the one or more detected keywords 180 (e.g., “Alarm Clock”) to generate one or more objects 122 (e.g., clip art of a clock) that are associated with the one or more detected keywords 180, as further described with reference to FIGS. 6 and 7. The adaptive classifier 144 is configured to add the one or more objects 122 (e.g., newly generated objects) to the one or more objects 182 associated with the one or more detected keywords 180. In a particular aspect, the adaptive classifier 144 is configured to update the object keyword data 124 to indicate that the one or more objects 122 (e.g., newly generated objects) are associated with one or more keywords 120 (e.g., the one or more detected keywords 180).

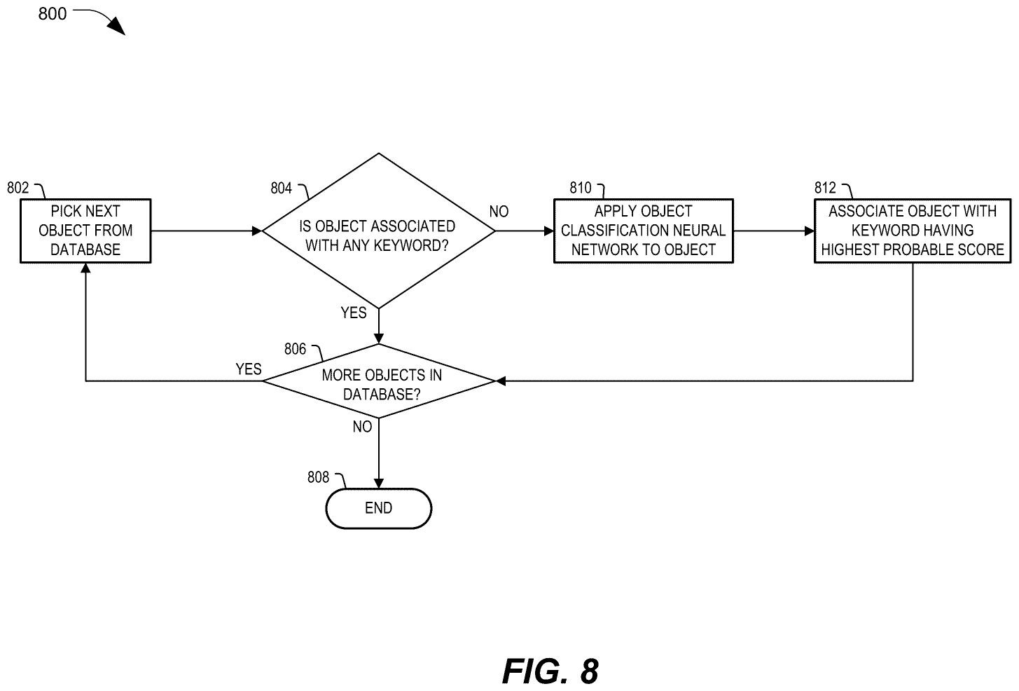

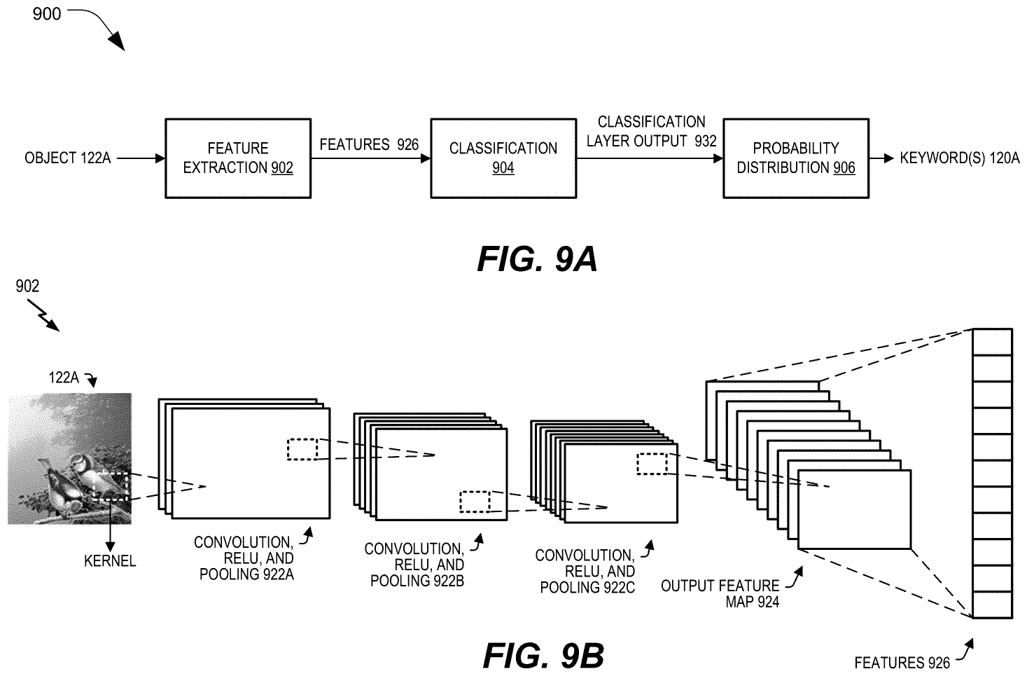

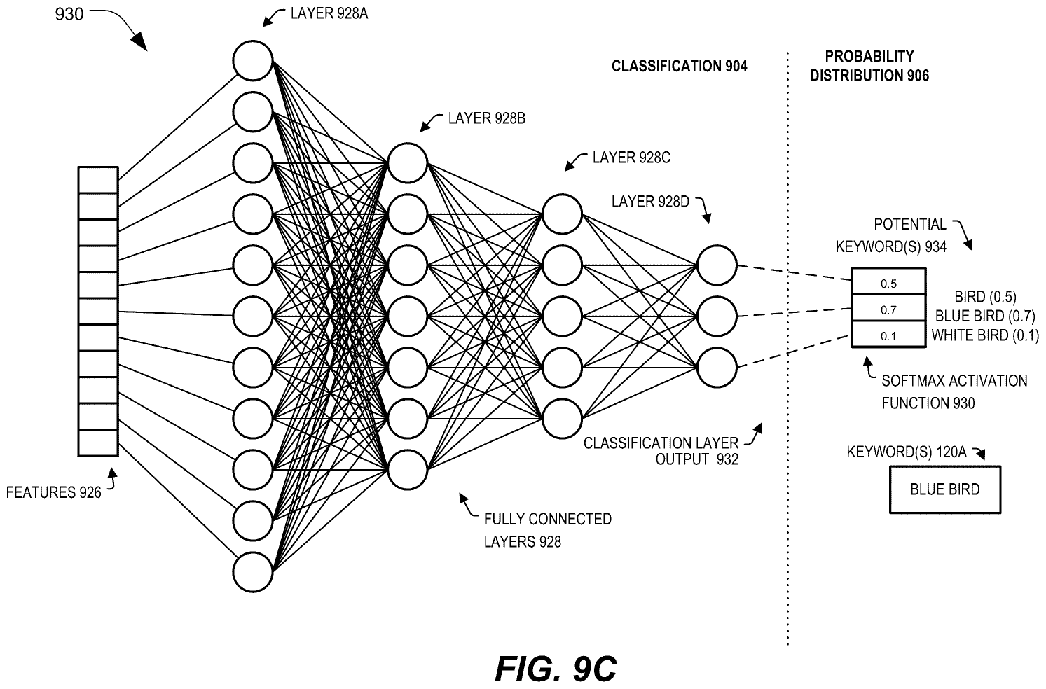

The object classification neural network 142 is configured to classify objects 122 that are stored in the database 150 (e.g., pre-existing objects). For example, the object classification neural network 142 is configured to process an object 122A (e.g., the image of the Statue of Liberty) to generate one or more keywords 120A (e.g., “New York” and “Statue of Liberty”) associated with the object 122A, as further described with reference to FIGS. 9A-9C. As another example, the object classification neural network 142 is configured to process an object 122B (e.g., the clip art of a clock) to generate one or more keywords 120B (e.g., “Clock,” “Alarm,” and “Time”). The adaptive classifier 144 is configured to update the object keyword data 124 to indicate that the object 122A (e.g., the image of the Statue of Liberty) and the object 122B (e.g., the clip art of a clock) are associated with the one or more keywords 120A (e.g., “New York” and “Statue of Liberty”) and the one or more keywords 120B (e.g., “Clock,” “Alarm,” and “Time”), respectively.

The adaptive classifier 144 is configured to, subsequent to generating (e.g., updating) the one or more keywords 120 associated with the set of objects 122, determine whether the set of objects 122 includes at least one object 122 that is associated with the one or more detected keywords 180. The adaptive classifier 144 is configured to, in response to determining that at least one of the one or more keywords 120A (e.g., “New York” and “Statue of Liberty”) matches at least one of the one or more detected keywords 180 (e.g., “New York City”), add the object 122A (e.g., the newly classified object) to the one or more objects 182 associated with the one or more detected keywords 180.

In some aspects, the adaptive classifier 144, in response to determining that the object keyword data 124 indicates that an object 122 is associated with at least one keyword 120 that matches at least one of the one or more detected keywords 180, determines that the object 122 is associated with the one or more detected keywords 180.

In some implementations, the adaptive classifier 144 is configured to determine that a keyword 120 matches a detected keyword 180 in response to determining that the keyword 120 is the same as the detected keyword 180 or that the keyword 120 is a synonym of the detected keyword 180. Optionally, in some implementations, the adaptive classifier 144 is configured to generate a first vector that represents the keyword 120 and to generate a second vector that represents the detected keyword 180. In these implementations, the adaptive classifier 144 is configured to determine that the keyword 120 matches the detected keyword 180 in response to determining that a vector distance between the first vector and the second vector is less than a distance threshold.

The adaptive classifier 144 is configured to adaptively classify the one or more objects 182 associated with the one or more detected keywords 180. For example, in a particular implementation, the adaptive classifier 144 is configured to, in response to selecting one or more of the objects 122 (e.g., pre-existing and pre-classified objects) stored in the database 150 to include in the one or more objects 182, refrain from classifying the one or more objects 182. Alternatively, the adaptive classifier 144 is configured to, in response to determining that none of the objects 122 (e.g., pre-existing and pre-classified objects) are associated with the one or more detected keywords 180, classify the one or more objects 182 associated with the one or more detected keywords 180.

In some examples, classifying the one or more objects 182 includes using the object generation neural network 140 to generate at least one of the one or more objects 182 (e.g., newly generated objects) that are associated with at least one of the one or more detected keywords 180. In some examples, classifying the one or more objects 182 includes using the object classification neural network 142 to designate one or more of the objects 122 (e.g., newly classified objects) as associated with one or more keywords 120, and adding at least one of the objects 122 having a keyword 120 that matches at least one detected keyword 180 to the one or more objects 182.

Optionally, in some examples, the adaptive classifier 144 uses the object generation neural network 140 and does not use the object classification neural network 142 to classify the one or more objects 182. To illustrate, in these examples, the adaptive classifier 144 includes the object generation neural network 140, and the object classification neural network 142 can be deactivated or, optionally, omitted from the adaptive classifier 144.

Optionally, in some examples, the adaptive classifier 144 uses the object classification neural network 142 and does not use the object generation neural network 140 to classify the one or more objects 182. To illustrate, in these examples, the adaptive classifier 144 includes the object classification neural network 142, and the object generation neural network 140 can be deactivated or, optionally, omitted from the adaptive classifier 144.

Optionally, in some examples, adaptive classifier 144 uses the object generation neural network 140 and uses the object classification neural network 142 to classify the one or more objects 182. To illustrate, in these examples, the adaptive classifier 144 includes the object generation neural network 140 and the object classification neural network 142.

Optionally, in some examples, the adaptive classifier 144 uses the object generation neural network 140 in response to determining that using the object classification neural network 142 has not resulted in any of the objects 122 being classified as associated with the one or more detected keywords 180. To illustrate, in these examples, the object generation neural network 140 is used adaptively based on the results of using the object classification neural network 142.

The adaptive classifier 144 is configured to provide the one or more objects 182 that are associated with the one or more detected keywords 180 to the object insertion unit 116. The one or more objects 182 include one or more pre-existing and pre-classified objects selected by the adaptive classifier 144, one or more objects newly generated by the object generation neural network 140, one or more objects newly classified by the object classification neural network 142, or a combination thereof. Optionally, in some implementations, the adaptive classifier 144 is also configured to provide the one or more objects 182 (or at least type information of the one or more objects 182) to the location determination unit 170.

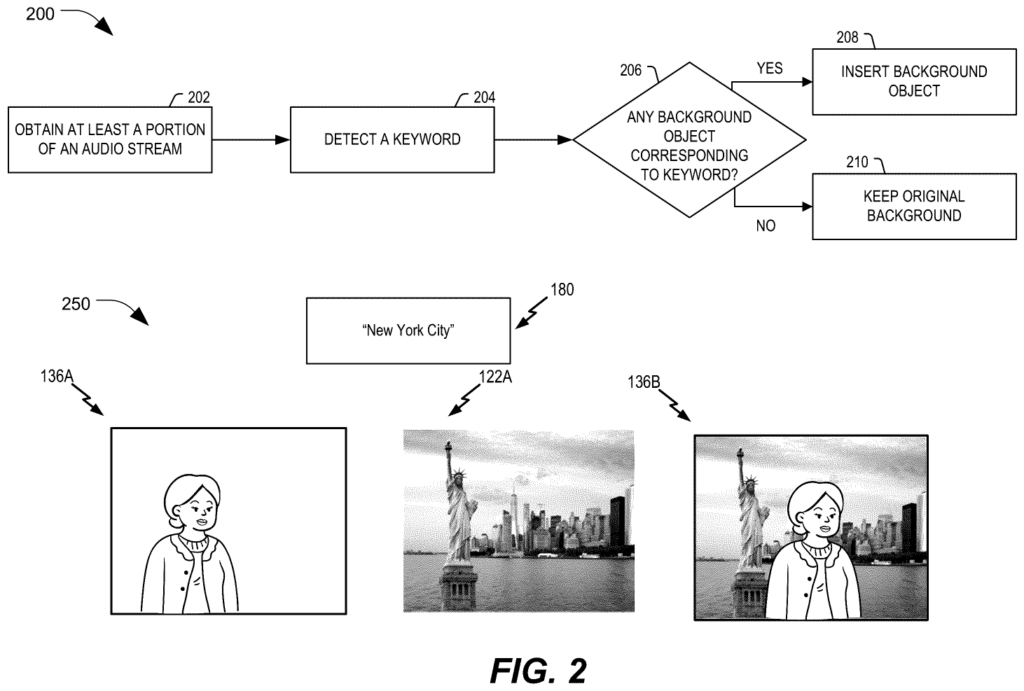

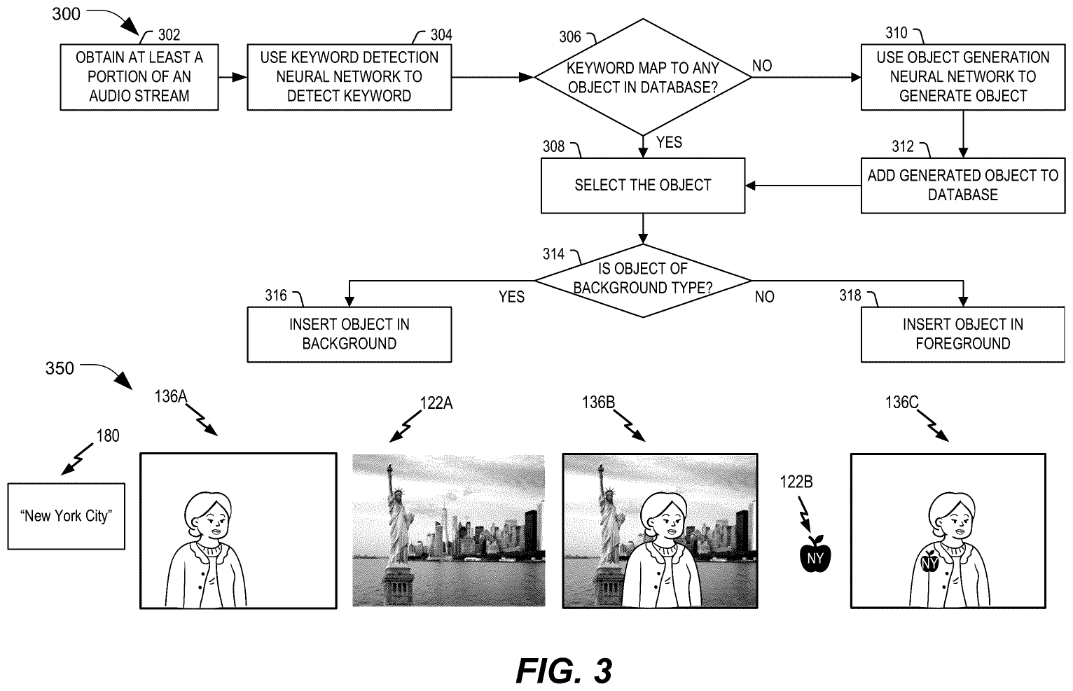

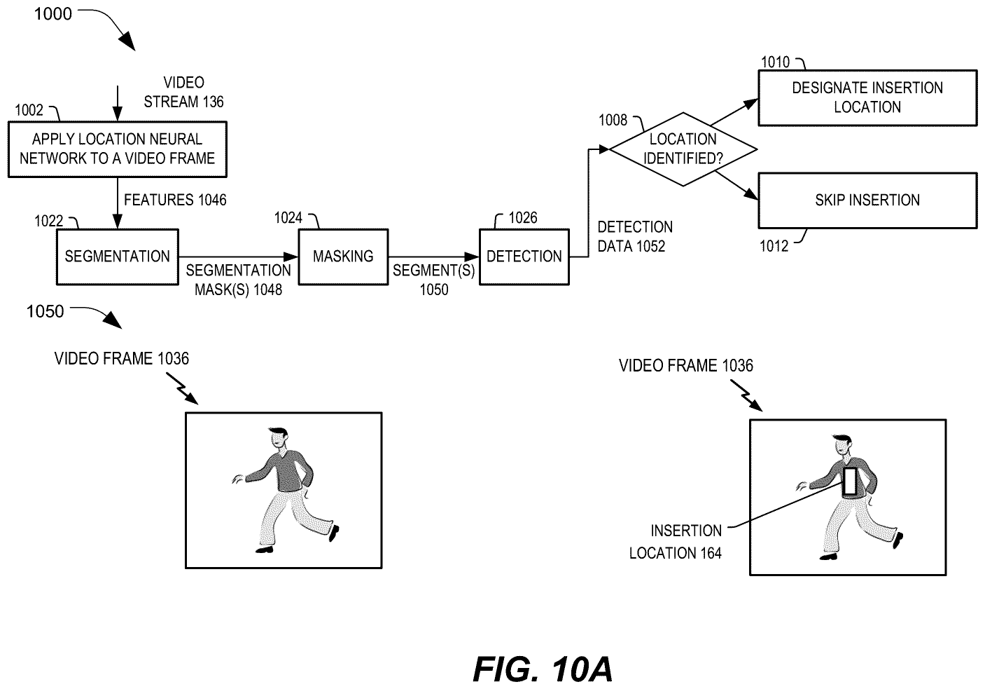

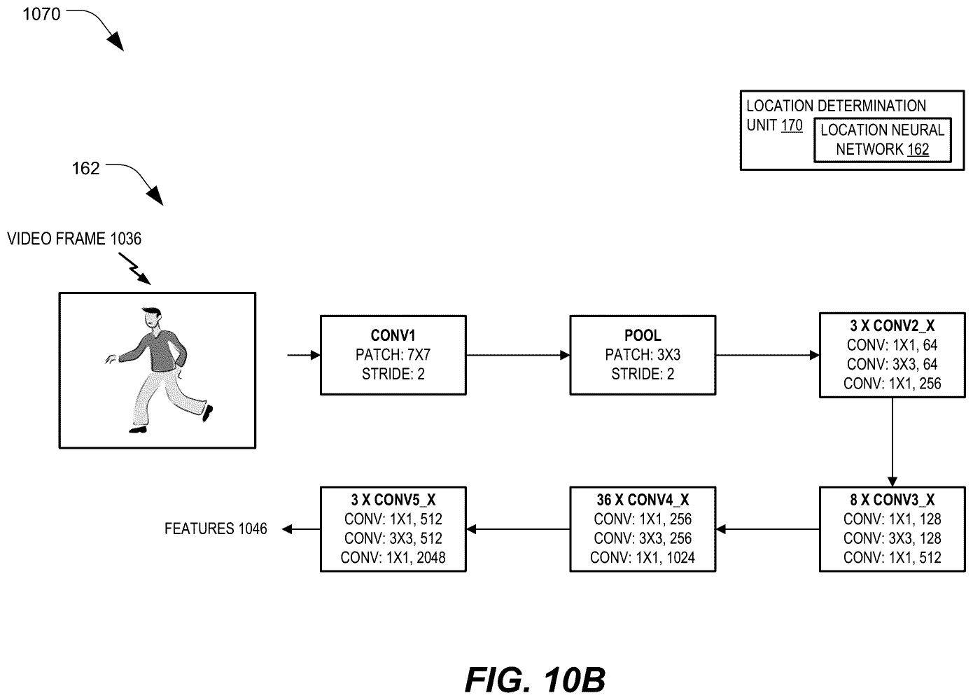

Optionally, in some implementations, the location determination unit 170 is configured to determine one or more insertion locations 164 and to provide the one or more insertion locations 164 to the object insertion unit 116. In some implementations, the location determination unit 170 is configured to determine the one or more insertion locations 164 based at least in part on an object type of the one or more objects 182, as further described with reference to FIGS. 2-3. In some implementations, the location determination unit 170 is configured to apply a location neural network 162 to at least a portion of a video stream 136 to determine the one or more insertion locations 164, as further described with reference to FIG. 10.

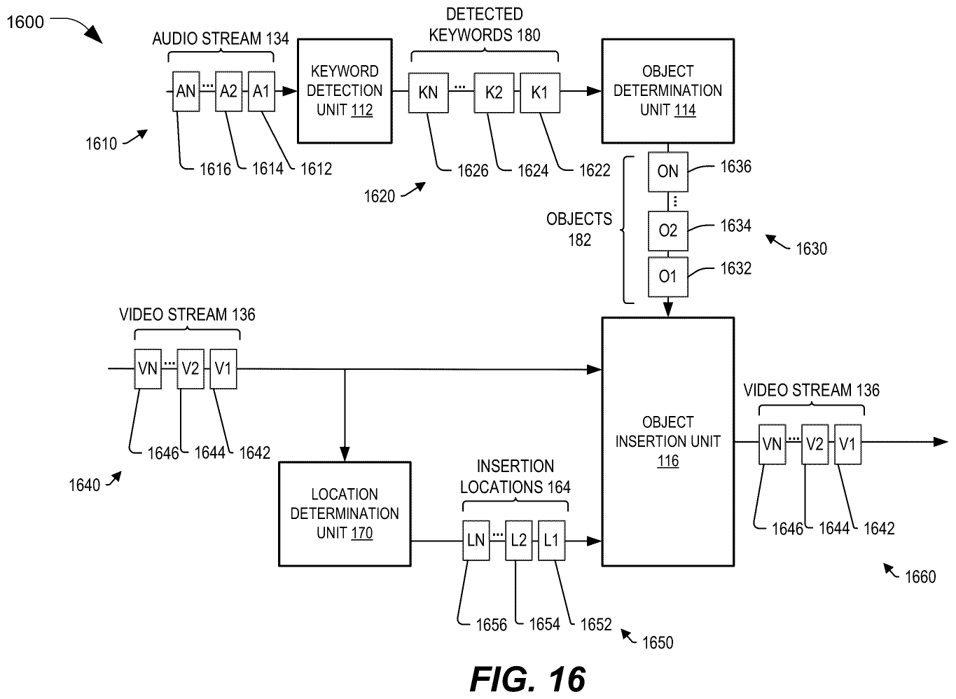

In a particular aspect, an insertion location 164 corresponds to a specific position (e.g., background, foreground, top, bottom, particular coordinates, etc.) in an image frame of the video stream 136 or specific content (e.g., a shirt, a picture frame, etc.) in an image frame of the video stream 136. For example, during live media processing, the one or more insertion locations 164 can indicate a position (e.g., foreground), content (e.g., a shirt), or both (e.g., a shirt in the foreground) within each of one or more particular frames of the video stream 136 that are presented at substantially the same time as the corresponding detected keywords 180 are played out. In some aspects, the one or more particular image frames are time-aligned with one or more audio frames of the audio stream 134 which were processed to determine the one or more detected keywords 180, as further described with reference to FIG. 16.

In some implementations without the location determination unit 170 to determine the one or more insertion locations 164, the one or more insertion locations 164 correspond to one or more pre-determined insertion locations that can be used by the object insertion unit 116. Non-limiting illustrative examples of pre-determined insertion locations include background, bottom-right, scrolling at the bottom, or a combination thereof. In a particular aspect, the one or more pre-determined locations are based on default data, a configuration setting, a user input, or a combination thereof.

The object insertion unit 116 is configured to insert the one or more objects 182 at the one or more insertion locations 164 in the video stream 136. In some examples, the object insertion unit 116 is configured to perform round-robin insertion of the one or more objects 182 if the one or more objects 182 include multiple objects that are to be inserted at the same insertion location 164. For example, the object insertion unit 116 performs round-robin insertion of a first subset (e.g., multiple images) of the one or more objects 182 at a first insertion location 164 (e.g., background), performs round-robin insertion of a second subset (e.g., multiple clip art, GIF files, etc.) of the one or more objects 182 at a second insertion location 164 (e.g., shirt), and so on. In other examples, the object insertion unit 116 is configured to, in response to determining that the one or more objects 182 include multiple objects and that the one or more insertion locations 164 include multiple locations, insert an object 122A of the one or more objects 182 at a first insertion location (e.g., background) of the one or more insertion locations 164, insert an object 122B of the one or more objects 182 at a second insertion location (e.g., bottom right), and so on. The object insertion unit 116 is configured to output the video stream 136 (with the inserted one or more objects 182).

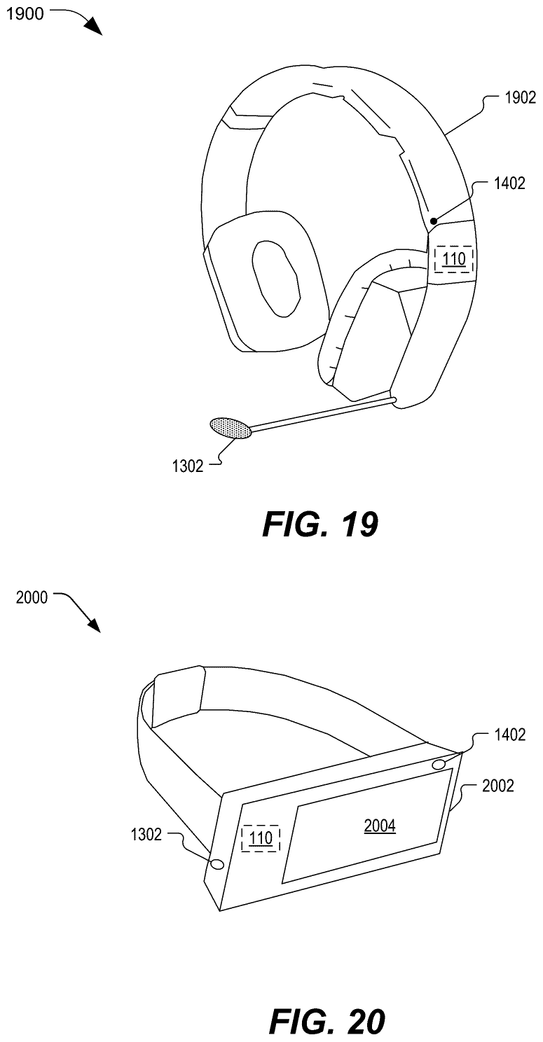

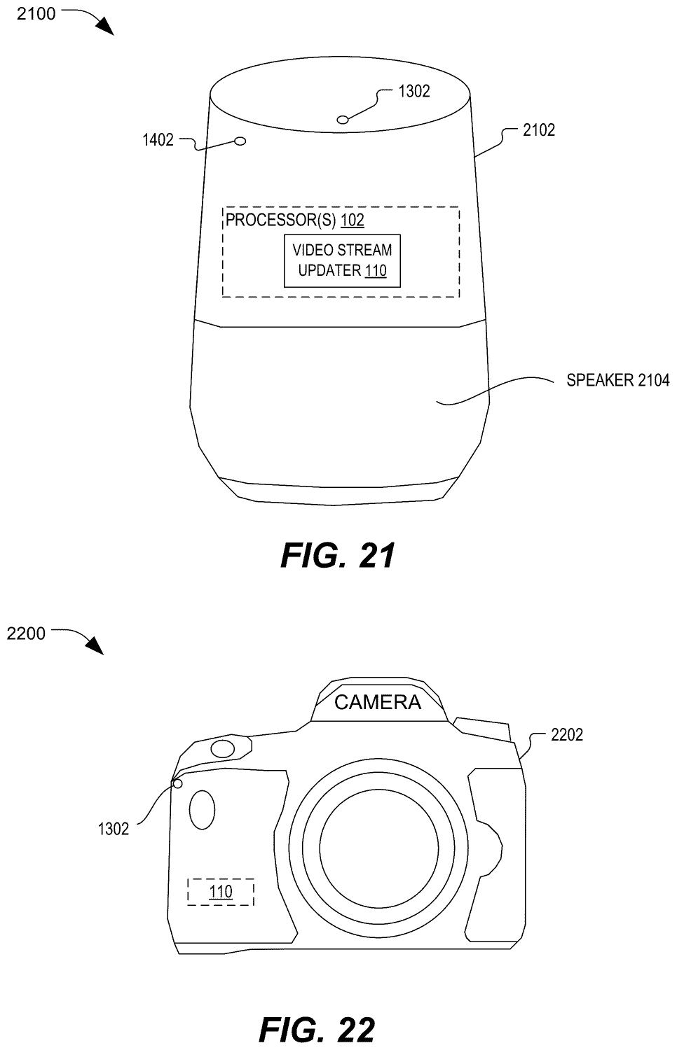

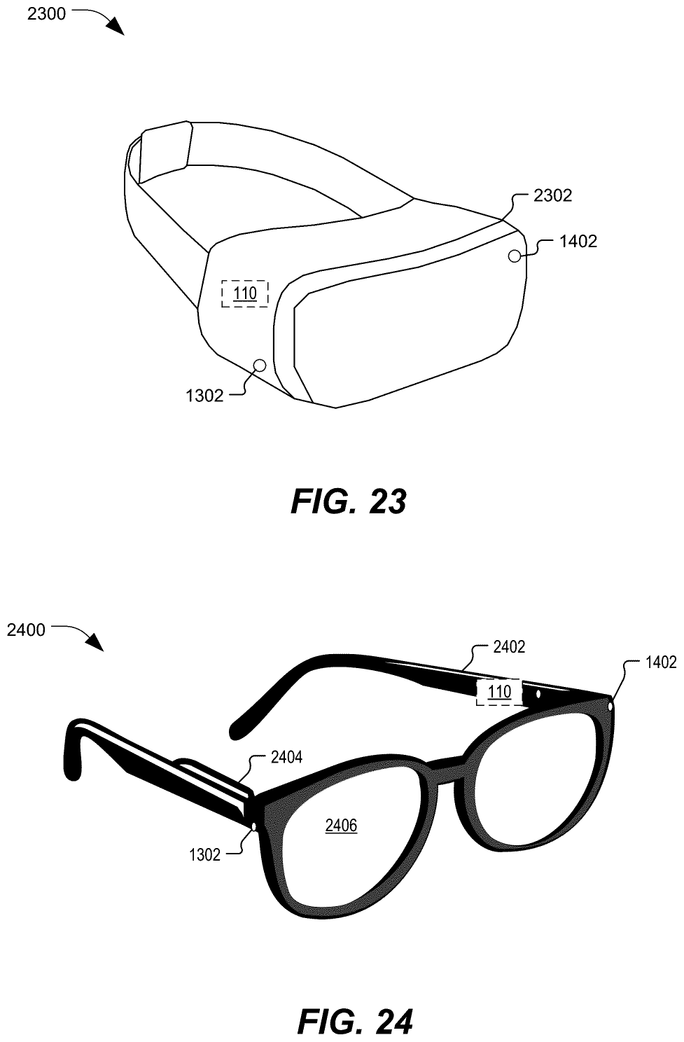

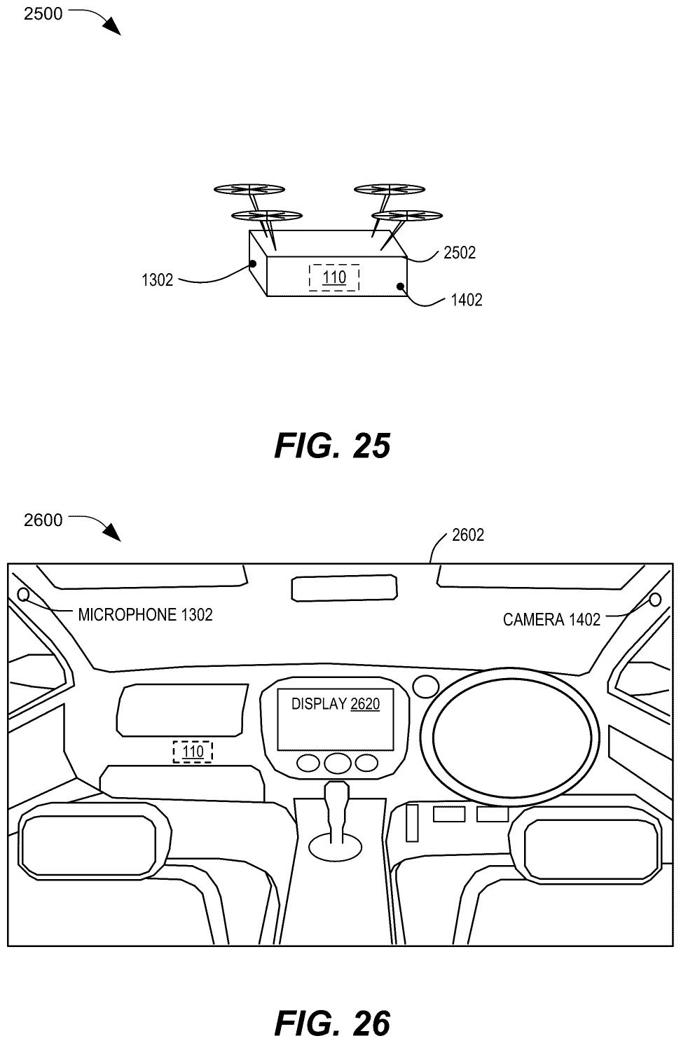

In some implementations, the device 130 corresponds to or is included in one of various types of devices. In an illustrative example, the one or more processors 102 are integrated in a headset device, such as described further with reference to FIG. 19. In other examples, the one or more processors 102 are integrated in at least one of a mobile phone or a tablet computer device, as described with reference to FIG. 18, a wearable electronic device, as described with reference to FIG. 20, a voice-controlled speaker system, as described with reference to FIG. 21, a camera device, as described with reference to FIG. 22, an extended reality (XR) headset, as described with reference to FIG. 23, or an XR glasses device, as described with reference to FIG. 24. In another illustrative example, the one or more processors 102 are integrated into a vehicle, such as described further with reference to FIG. 25 and FIG. 26.

During operation, the video stream updater 110 obtains an audio stream 134 and a video stream 136. In a particular aspect, the audio stream 134 is a live stream that the video stream updater 110 receives in real-time from a microphone, a network device, another device, or a combination thereof. In a particular aspect, the video stream 136 is a live stream that the video stream updater 110 receives in real-time from a camera, a network device, another device, or a combination thereof.

Optionally, in some implementations, a media stream (e.g., a live media stream) includes the audio stream 134 and the video stream 136, as further described with reference to FIG. 11. Optionally, in some implementations, at least one of the audio stream 134 or the video stream 136 corresponds to decoded data generated by a decoder by decoding encoded data received from another device, as further described with reference to FIG. 12. Optionally, in some implementations, the video stream updater 110 receives the audio stream 134 from one or more microphones coupled to the device 130, as further described with reference to FIG. 13. Optionally, in some implementations, the video stream updater 110 receives the video stream 136 from one or more cameras coupled to the device 130, as further described with reference to FIG. 14.

The keyword detection unit 112 processes the audio stream 134 to determine one or more detected keywords 180 in the audio stream 134. In some examples, the keyword detection unit 112 processes a pre-determined count of audio frames of the audio stream 134, audio frames of the audio stream 134 that correspond to a pre-determined playback time, or both. In a particular aspect, the pre-determined count of audio frames, the pre-determined playback time, or both, are based on default data, a configuration setting, a user input, or a combination thereof.

In some implementations, the keyword detection unit 112 omits (or does not use) the keyword detection unit 112 and instead uses speech recognition techniques to determine one or more words represented in the audio stream 134 and semantic analysis techniques to process the one or more words to determine the one or more detected keywords 180. Optionally, in some implementations, the keyword detection unit 112 applies the keyword detection neural network 160 to process one or more audio frames of the audio stream 134 to determine (e.g., detect) one or more detected keywords 180 in the audio stream 134, as further described with reference to FIG. 4. In some aspects, applying the keyword detection neural network 160 includes extracting acoustic features of the one or more audio frames to generate input values, and using the keyword detection neural network 160 to process the input values to determine the one or more detected keywords 180 corresponding to the acoustic features. A technical effect of applying the keyword detection neural network 160, as compared to using speech recognition and semantic analysis, can include using fewer resources (e.g., time, computing cycles, memory, or a combination thereof) and improving accuracy in determining the one or more detected keywords 180.

In an example, the adaptive classifier 144 first performs a database search or lookup operation based on a comparison of the one or more database keywords 120 and the one or more detected keywords 180 to determine whether the set of objects 122 includes any objects that are associated with the one or more detected keywords 180. The adaptive classifier 144, in response to determining that the set of objects 122 includes at least one object 122 that is associated with the one or more detected keywords 180, refrains from classifying the one or more objects 182 associated with the one or more detected keywords 180.

In the example 190, the keyword detection unit 112 determines the one or more detected keywords 180 (e.g., “New York City”) in an audio stream 134 that is associated with a video stream 136A. In response to determining that the set of objects 122 includes the object 122A (e.g., an image of the Statue of Liberty) that is associated with the one or more keywords 120A (e.g., “New York” and “Statue of Liberty”) and determining that at least one of the one or more keywords 120A matches at least one of the one or more detected keywords 180 (e.g., “New York City”), the adaptive classifier 144 determines that the object 122A is associated with the one or more detected keywords 180. The adaptive classifier 144, in response to determining that the object 122A is associated with the one or more detected keywords 180, includes the object 122A in the one or more objects 182, and refrains from classifying the one or more objects 182 associated with the one or more detected keywords 180.

In the example 192, the keyword detection unit 112 determines the one or more detected keywords 180 (e.g., “Alarm Clock”) in the audio stream 134 that is associated with the video stream 136A. The keyword detection unit 112 provides the one or more detected keywords 180 to the adaptive classifier 144. In response to determining that the set of objects 122 includes the object 122B (e.g., clip art of a clock) that is associated with the one or more keywords 120B (e.g., “Clock,” “Alarm,” and “Time”) and determining that at least one of the one or more keywords 120B matches at least one of the one or more detected keywords 180 (e.g., “Alarm Clock”), the adaptive classifier 144 determines that the object 122B is associated with the one or more detected keywords 180. The adaptive classifier 144, in response to determining that the object 122B is associated with the one or more detected keywords 180, includes the object 122B in the one or more objects 182, and refrains from classifying the one or more objects 182 associated with the one or more detected keywords 180.

In an alternative example, in which the database search or lookup operation does not detect any object associated with the one or more detected keywords 180 (e.g., “New York City” in the example 190 or “Alarm Clock” in the example 192), the adaptive classifier 144 classifies the one or more objects 182 associated with the one or more detected keywords 180.

Optionally, in some aspects, classifying the one or more objects 182 includes using the object classification neural network 142 to determine whether any of the set of objects 122 can be classified as associated with the one or more detected keywords 180, as further described with reference to FIGS. 9A-9C. For example, using the object classification neural network 142 can include performing feature extraction of an object 122 of the set of objects 122 to determine input values representing the object 122, performing classification based on the input values to determine one or more potential keywords that are likely associated with the object 122, and generating a probability distribution indicating a likelihood of each of the one or more potential keywords being associated with the object 122. The adaptive classifier 144 designates, based on the probability distribution, one or more of the potential keywords as one or more keywords 120 associated with the object 122. The adaptive classifier 144 updates the object keyword data 124 to indicate that the object 122 is associated with the one or more keywords 120 generated by the object classification neural network 142.

As an example, the adaptive classifier 144 uses the object classification neural network 142 to process the object 122A (e.g., the image of the Statue of Liberty) to generate the one or more keywords 120A (e.g., “New York” and “Statue of Liberty”) associated with the object 122A. The adaptive classifier 144 updates the object keyword data 124 to indicate that the object 122A (e.g., the image of the Statue of Liberty) is associated with the one or more keywords 120A (e.g., “New York” and “Statue of Liberty”). As another example, the adaptive classifier 144 uses the object classification neural network 142 to process the object 122B (e.g., the clip art of the clock) to generate the one or more keywords 120B (e.g., “Clock,” “Alarm,” and “Time”) associated with the object 122B. The adaptive classifier 144 updates the object keyword data 124 to indicate that the object 122B (e.g., the clip art of the clock) is associated with the one or more keywords 120B (e.g., “Clock,” “Alarm,” and “Time”).

The adaptive classifier 144, subsequent to updating the object keyword data 124 (e.g., after applying the object classification neural network 142 to each of the objects 122), determines whether any object of the set of objects 122 is associated with the one or more detected keywords 180. The adaptive classifier 144, in response to determining that an object 122 is associated with the one or more detected keywords 180, adds the object 122 to the one or more objects 182. In the example 190, the adaptive classifier 144, in response to determining that the object 122A (e.g., the image of the Statue of Liberty) is associated with the one or more detected keywords 180 (e.g., “New York City”), adds the object 122A to the one or more objects 182. In the example 192, the adaptive classifier 144, in response to determining that the object 122B (e.g., the clip art of the clock) is associated with the one or more detected keywords 180 (e.g., “Alarm Clock”), adds the object 122B to the one or more objects 182. In some implementations, the adaptive classifier 144, in response to determining that at least one object has been included in the one or more objects 182, refrains from applying the object generation neural network 140 to determine the one or more objects 182 associated with the one or more detected keywords 180.

Optionally, in some implementations, classifying the one or more objects 182 includes applying the object generation neural network 140 to the one or more detected keywords 180 to generate one or more objects 182. In some aspects, the adaptive classifier 144 applies the object generation neural network 140 in response to determining that no objects have been included in the one or more objects 182. For example, in implementations that do not include applying the object classification neural network 142, or subsequent to applying the object classification neural network 142 but not detecting a matching object for the one or more detected keywords 180, the adaptive classifier 144 applies the object generation neural network 140.

In some aspects, the object determination unit 114 applies the object classification neural network 142 independently of whether any pre-existing objects have already been included in the one or more objects 182, in order to update classification of the objects 122. For example, in these aspects, the adaptive classifier 144 includes the object generation neural network 140, whereas the object classification neural network 142 is external to the adaptive classifier 144. To illustrate, in these aspects, classifying the one or more objects 182 includes selectively applying the object generation neural network 140 in response to determining that no objects (e.g., no pre-existing objects) have been included in the one or more objects 182, whereas the object classification neural network 142 is applied independently of whether any pre-existing objects have already been included in the one or more objects 182. In these aspects, resources are used to classify the objects 122 of the database 150, and resources are selectively used to generate new objects.

In some aspects, the object determination unit 114 applies the object generation neural network 140 independently of whether any pre-existing objects have already been included in the one or more objects 182, in order to generate one or more additional objects to add to the one or more objects 182. For example, in these aspects, the adaptive classifier 144 includes the object classification neural network 142, whereas the object generation neural network 140 is external to the adaptive classifier 144. To illustrate, in these aspects, classifying the one or more objects 182 includes selectively applying the object classification neural network 142 in response to determining that no objects (e.g., no pre-existing and pre-classified objects) have been included in the one or more objects 182, whereas the object generation neural network 140 is applied independently of whether any pre-existing objects have already been included in the one or more objects 182. In these aspects, resources are used to add newly generated objects to the database 150, and resources are selectively used to classify the objects 122 of the database 150 that are likely already classified.

In some implementations, the object generation neural network 140 includes stacked generative adversarial networks (GANs). For example, applying the object generation neural network 140 to a detected keyword 180 includes generating an embedding representing a detected keyword 180, using a stage-1 GAN to generate a lower-resolution object based at least in part on the embedding, and using a stage-2 GAN to refine the lower-resolution object to generate a higher-resolution object, as further described with reference to FIG. 7. The adaptive classifier 144 adds the newly generated, higher-resolution object to the set of objects 122, updates the object keyword data 124 indicating that the high-resolution object is associated with the detected keyword 180, and adds the newly generated object to the one or more objects 182.

In the example 190, if none of the objects 122 are associated with the one or more detected keywords 180 (e.g., “New York City”), the adaptive classifier 144 applies the object generation neural network 140 to the one or more detected keywords 180 (e.g., “New York City”) to generate the object 122A (e.g., an image of the Statue of Liberty). The adaptive classifier 144 adds the object 122A (e.g., an image of the Statue of Liberty) to the set of objects 122 in the database 150, updates the object keyword data 124 to indicate that the object 122A is associated with the one or more detected keywords 180 (e.g., “New York City”), and adds the object 122A to the one or more objects 182.

In the example 192, if none of the objects 122 are associated with the one or more detected keywords 180 (e.g., “Alarm Clock”), the adaptive classifier 144 applies the object generation neural network 140 to the one or more detected keywords 180 (e.g., “Alarm Clock”) to generate the object 122B (e.g., clip art of a clock). The adaptive classifier 144 adds the object 122B (e.g., clip art of a clock) to the set of objects 122 in the database 150, updates the object keyword data 124 to indicate that the object 122B is associated with the one or more detected keywords 180 (e.g., “Alarm Clock”), and adds the object 122B to the one or more objects 182.

The adaptive classifier 144 provides the one or more objects 182 to the object insertion unit 116 to insert the one or more objects 182 at one or more insertion locations 164 in the video stream 136. In some implementations, the one or more insertion locations 164 are pre-determined. For example, the one or more insertion locations 164 are based on default data, a configuration setting, user input, or a combination thereof. In some aspects, the pre-determined insertion locations 164 can include position-specific locations, such as background, foreground, bottom, corner, center, etc. of video frames.

Optionally, in some implementations in which the video stream updater 110 includes the location determination unit 170, the adaptive classifier 144 also provides the one or more objects 182 (or at least type information of the one or more objects 182) to the location determination unit 170 to dynamically determine the one or more insertion locations 164. In some examples, the one or more insertion locations 164 can include position-specific locations, such as background, foreground, top, middle, bottom, corner, diagonal, or a combination thereof. In some examples, the one or more insertion locations 164 can include content-specific locations, such as a front of a shirt, a playing field, a television, a whiteboard, a wall, a picture frame, another element depicted in a video frame, or a combination thereof. Using the location determination unit 170 enables dynamic selection of elements in the content of the video stream 136 as one or more insertion locations 164.

In some implementations, the location determination unit 170 performs image comparisons of portions of video frames of the video stream 136 to stored images of potential locations to identify the one or more insertion locations 164. Optionally, in some implementations in which the location determination unit 170 includes the location neural network 162, the location determination unit 170 applies the location neural network 162 to the video stream 136 to determine one or more insertion locations 164 in the video stream 136. For example, the location determination unit 170 applies the location neural network 162 to a video frame of the video stream 136 to determine the one or more insertion locations 164, as further described with reference to FIG. 10. A technical effect of using the location neural network 162 to identify insertion locations, as compared to performing image comparison to identify insertion locations, can include using fewer resources (e.g., time, computing cycles, memory, or a combination thereof), having higher accuracy, or both, in determining the one or more insertion locations 164.

The object insertion unit 116 receives the one or more objects 182 from the adaptive classifier 144. In some implementations, the object insertion unit 116 uses one or more pre-determined locations as the one or more insertion locations 164. In other implementations, the object insertion unit 116 receives the one or more insertion locations 164 from the location determination unit 170.

The object insertion unit 116 inserts the one or more objects 182 at the one or more insertion locations 164 in the video stream 136. In the example 190, the object insertion unit 116, in response to determining that an insertion location 164 (e.g., background) is associated with the object 122A (e.g., image of the Statue of Liberty) included in the one or more objects 182, inserts the object 122A as a background in one or more video frames of the video stream 136A to generate a video stream 136B. In the example 192, the object insertion unit 116, in response to determining that an insertion location 164 (e.g., foreground) is associated with the object 122B (e.g., clip art of a clock) included in the one or more objects 182, inserts the object 122B as a foreground object in one or more video frames of the video stream 136A to generate a video stream 136B.

In some implementations, an insertion location 164 corresponds to an element (e.g., a front of a shirt) depicted in a video frame. The object insertion unit 116 inserts an object 122 at the insertion location 164 (e.g., the shirt), and the insertion location 164 can change positions in the one or more video frames of the video stream 136A to follow the movement of the element. For example, the object insertion unit 116 determines a first position of the element (e.g., the shirt) in a first video frame and inserts the object 122 at the first position in the first video frame. As another example, the object insertion unit 116 determines a second position of the element (e.g., the shirt) in a second video frame and inserts the object 122 at the second position in the second video frame. If the element has changed positions between the first video frame and the second video frame, the first position can be different from the second position.

In a particular example, the one or more objects 182 include a single object 122 and the one or more insertion locations 164 includes multiple insertion locations 164. In some implementations, the object insertion unit 116 selects one of the insertion locations 164 for insertion of the object 122, while in other implementations the object insertion unit 116 inserts copies of the object 122 at two or more of the multiple insertion locations 164 in the video stream 136. In some implementations, the object insertion unit 116 performs a round-robin insertion of the object 122 at the multiple insertion locations 164. For example, the object insertion unit 116 inserts the object 122 in a first location of the multiple insertion locations 164 in a first set of video frames of the video stream 136, inserts the object 122 in a second location of the one or more insertion locations 164 (and not in the first location) in a second set of video frames of the video stream 136 that is distinct from the first set of video frames, and so on.

In a particular example, the one or more objects 182 include multiple objects 122 and the one or more insertion locations 164 include multiple insertion locations 164. In some implementations, the object insertion unit 116 performs round-robin insertion of the multiple objects 122 at the multiple insertion locations 164. For example, the object insertion unit 116 inserts a first object 122 at a first insertion location 164 in a first set of video frames of the video stream 136, inserts a second object 122 at a second insertion location 164 (without the first object 122 in the first insertion location 164) in a second set of video frames of the video stream 136 that is distinct from the first set of video frames, and so on.

In a particular example, the one or more objects 182 include multiple objects 122 and the one or more insertion locations 164 include a single insertion location 164. In some implementations, the object insertion unit 116 performs round-robin insertion of the multiple objects 122 at the single insertion location 164. For example, the object insertion unit 116 inserts a first object 122 at the insertion location 164 in a first set of video frames of the video stream 136, inserts a second object 122 (and not the first object 122) at the insertion location 164 in a second set of video frames of the video stream 136 that is distinct from the first set of video frames, and so on.

The object insertion unit 116 outputs the video stream 136 subsequent to inserting the one or more objects 182 in the video stream 136. In some implementations, the object insertion unit 116 provides the video stream 136 to a display device, a network device, a storage device, a cloud-based resource, or a combination thereof.

The system 100 thus enables enhancement of the video stream 136 with the one or more objects 182 that are associated with the one or more detected keywords 180. Enhancements to the video stream 136 can improve audience retention, create advertising opportunities, etc. For example, adding objects to the video stream 136 can make the video stream 136 more interesting to the audience. To illustrate, adding the object 122A (e.g., image of the Statue of Liberty) can increase audience retention for the video stream 136 when the audio stream 134 includes one or more detected keywords 180 (e.g., “New York City”) that are associated with the object 122A. In another example, an object 122A can be associated with a related entity (e.g., an image of a restaurant in New York, a restaurant serving food that is associated with New York, another business selling New York related food or services, a travel website, or a combination thereof) that is associated with the one or more detected keywords 180.

Although the video stream updater 110 is illustrated as including the location determination unit 170, in some other implementations the location determination unit 170 is excluded from the video stream updater 110. For example, in implementations in which the location determination unit 170 is deactivated or omitted from the location determination unit 170, the object insertion unit 116 uses one or more pre-determined locations as the one or more insertion locations 164. Using the location determination unit 170 enables dynamic determination of the one or more insertion locations 164, including content-specific insertion locations.

Although the adaptive classifier 144 is illustrated as including the object generation neural network 140 and the object classification neural network 142, in some other implementations the object generation neural network 140 or the object classification neural network 142 is excluded from the video stream updater 110. For example, adaptively classifying the one or more objects 182 can include selectively applying the object generation neural network 140. In some implementations, the object determination unit 114 does not include the object classification neural network 142 so resources are not used to re-classify objects that are likely already classified. In other implementations, the object determination unit 114 includes the object classification neural network 142 external to the adaptive classifier 144 so objects are classified independently of the adaptive classifier 144. In an example, adaptively classifying the one or more objects 182 can include selectively applying the object classification neural network 142. In some implementations, the object determination unit 114 does not include the object generation neural network 140 so resources are not used to generate new objects. In other implementations, the object determination unit 114 includes the object generation neural network 140 external to the adaptive classifier 144 so new objects are generated independently of the adaptive classifier 144.

Using the object generation neural network 140 to generate a new object is provided as an illustrative example. In other examples, another type of object generator, that does not include a neural network, can be used as an alternative or in addition to the object generation neural network 140 to generate a new object. Using the object classification neural network 142 to perform a classification of an object is provided as an illustrative example. In other examples, another type of object classifier, that does not include a neural network, can be used as an alternative or in addition to the object classification neural network 142 to perform a classification of an object.

Although the keyword detection unit 112 is illustrated as including the keyword detection neural network 160, in some other implementations the keyword detection unit 112 can process the audio stream 134 to determine the one or more detected keywords 180 independently of any neural network. For example, the keyword detection unit 112 can determine the one or more detected keywords 180 using speech analysis and semantic analysis. Using the keyword detection neural network 160 (e.g., as compared to the speech recognition and semantic analysis) can include using fewer resources (e.g., time, computing cycles, memory, or a combination thereof), having higher accuracy, or both, in determining the one or more detected keywords 180.

Although the location determination unit 170 is illustrated as including the location neural network 162, in some other implementations the location determination unit 170 can determine the one or more insertion locations 164 independently of any neural network. For example, the location determination unit 170 can determine the one or more insertion locations 164 using image comparison. Using the location neural network 162 (e.g., as compared to image comparison) can include using fewer resources (e.g., time, computing cycles, memory, or a combination thereof), having higher accuracy, or both, in determining the one or more insertion locations 164.

Referring to FIG. 2, a particular implementation of a method 200 of keyword-based object insertion into a video stream, and an example 250 of keyword-based object insertion into a video stream are shown. In a particular aspect, one or more operations of the method 200 are performed by one or more of the keyword detection unit 112, the adaptive classifier 144, the location determination unit 170, the object insertion unit 116, the video stream updater 110, the one or more processors 102, the device 130, the system 100 of FIG. 1, or a combination thereof.

The method 200 includes obtaining at least a portion of an audio stream, at 202. For example, the keyword detection unit 112 of FIG. 1 obtains one or more audio frames of the audio stream 134, as described with reference to FIG. 1.

The method 200 also includes detecting a keyword, at 204. For example, the keyword detection unit 112 of FIG. 1 processes the one or more audio frames of the audio stream 134 to determine the one or more detected keywords 180, as described with reference to FIG. 1. In the example 250, the keyword detection unit 112 processes the audio stream 134 to determine the one or more detected keywords 180 (e.g., “New York City”).

The method 200 further includes determining whether any background object corresponds to the keyword, at 206. In an example, the set of objects 122 of FIG. 1 corresponds to background objects. To illustrate, each of the set of objects 122 can be inserted into a background of a video frame. The adaptive classifier 144 determines whether any object of the set of objects 122 corresponds to (e.g., is associated with) the one or more detected keywords 180, as described with reference to FIG. 1.

The method 200 also includes, in response to determining that a background object corresponds to the keyword, at 206, inserting the background object, at 208. For example, the adaptive classifier 144, in response to determining that the object 122A corresponds to the one or more detected keywords 180, adds the object 122A to one or more objects 182 that are associated with the one or more detected keywords 180. The object insertion unit 116, in response to determining that the object 122A is included in the one or more objects 182 corresponding to the one or more detected keywords 180, inserts the object 122A in the video stream 136. In the example 250, the object insertion unit 116 inserts the object 122A (e.g., an image of the Statue of Liberty) in the video stream 136A to generate the video stream 136B.

Otherwise, in response to determining that no background object corresponds to the keyword, at 206, the method 200 includes keeping the original background, at 210. For example, the video stream updater 110, in response to the adaptive classifier 144 determining that the set of objects 122 does not include any background objects associated with the one or more detected keywords 180, bypasses the object insertion unit 116 and outputs one or more video frames of the video stream 136 unchanged (e.g., without inserting any background objects to the one or more video frames of the video stream 136A).

The method 200 thus enables enhancing the video stream 136 with a background object that is associated with the one or more detected keywords 180. When no background object is associated with the one or more detected keywords 180, a background of the video stream 136 remains unchanged.

Referring to FIG. 3, a particular implementation of a method 300 of keyword-based object insertion into a video stream, and a diagram 350 of examples of keyword-based object insertion into a video stream are shown. In a particular aspect, one or more operations of the method 300 are performed by one or more of the keyword detection unit 112, the adaptive classifier 144, the location determination unit 170, the object insertion unit 116, the video stream updater 110, the one or more processors 102, the device 130, the system 100 of FIG. 1, or a combination thereof.

The method 300 includes obtaining at least a portion of an audio stream, at 302. For example, the keyword detection unit 112 of FIG. 1 obtains one or more audio frames of the audio stream 134, as described with reference to FIG. 1.

The method 300 also includes using a keyword detection neural network to detect a keyword, at 304. For example, the keyword detection unit 112 of FIG. 1 uses the keyword detection neural network 160 to process the one or more audio frames of the audio stream 134 to determine the one or more detected keywords 180, as described with reference to FIG. 1.

The method 300 further includes determining whether the keyword maps to any object in a database, at 306. For example, the adaptive classifier 144 of FIG. 1 determines whether any object of the set of objects 122 stored in the database 150 corresponds to (e.g., is associated with) the one or more detected keywords 180, as described with reference to FIG. 1.

The method 300 includes, in response to determining that the keyword maps to an object in the database, at 306, selecting the object, at 308. For example, the adaptive classifier 144 of FIG. 1, in response to determining that the one or more detected keywords 180 (e.g., “New York City”) are associated with the object 122A (e.g., an image of the Statue of Liberty), selects the object 122A to add to the one or more objects 182 associated with the one or more detected keywords 180, as described with reference to FIG. 1. As another example, the adaptive classifier 144 of FIG. 1, in response to determining that the one or more detected keywords 180 (e.g., “New York City”) are associated with an object 122B (e.g., clip art of an apple with the letters “NY”), selects the object 122B to add to the one or more objects 182 associated with the one or more detected keywords 180, as described with reference to FIG. 1.

Otherwise, in response to determining that the keyword does not map to any object in the database, at 306, the method 300 includes using an object generation neural network to generate an object, at 310. For example, the adaptive classifier 144 of FIG. 1, in response to determining that none of the set of objects 122 are associated with the one or more detected keywords 180, uses the object generation neural network 140 to generate an object 122A (e.g., an image of the Statue of Liberty), an object 122B (e.g., clip art of an apple with the letters “NY”), one or more additional objects, or a combination thereof, as described with reference to FIG. 1. After generating the object, at 310, the method 300 includes adding the generated object to the database, at 312, and selecting the object, at 308. For example, the adaptive classifier 144 of FIG. 1 adds the object 122A, the object 122B, or both, to the database 150, and selects the object 122A, the object 122B, or both, to add to the one or more objects 182 associated with the one or more detected keywords 180, as described with reference to FIG. 1.

The method 300 also includes determining whether the object is of a background type, at 314. For example, the location determination unit 170 of FIG. 1 may determine whether an object 122 included in the one or more objects 182 is of a background type. The location determination unit 170, based on determining whether the object 122 is of the background type, designates an insertion location 164 for the object 122, as described with reference to FIG. 1. In a particular example, the location determination unit 170 of FIG. 1, in response to determining that the object 122A of the one or more objects 182 is of the background type, designates a first insertion location 164 (e.g., background) for the object 122A. As another example, the location determination unit 170, in response to determining that the object 122B of the one or more objects 182 is not of the background type, designates a second insertion location 164 (e.g., foreground) for the object 122B. In some implementations, the location determination unit 170, in response to determining that a location (e.g., background) of a video frame of the video stream 136 includes at least one object associated with the one or more detected keywords 180, selects another location (e.g., foreground) of the video frame as an insertion location 164.

In a particular implementation, a first subset of the set of objects 122 is stored in a background database and a second subset of the set of objects 122 is stored in a foreground database, both of which may be included in the database 150. In this implementation, the location determination unit 170, in response to determining that the object 122A is included in the background database, determines that the object 122A is of the background type. In an example, the location determination unit 170, in response to determining that the object 122B is included in the foreground database, determines that the object 122B is of a foreground type and not of the background type.

In some implementations, the first subset and the second subset are non-overlapping. For example, an object 122 is included in either the background database or the foreground database, but not both. However, in other implementations, the first subset at least partially overlaps the second subset. For example, a copy of an object 122 can be included in each of the background database and the foreground database.

In a particular implementation, an object type of an object 122 is based on a file type (e.g., an image file, a GIF file, a PNG file, etc.) of the object 122. For example, the location determination unit 170, in response to determining that the object 122A is an image file, determines that the object 122A is of the background type. In another example, the location determination unit 170, in response to determining that the object 122B is not an image file (e.g., the object 122B is a GIF file or a PNG file), determines that the object 122B is of the foreground type and not of the background type.

In a particular implementation, metadata of the object 122 indicates whether the object 122 is of a background type or a foreground type. For example, the location determination unit 170, in response to determining that metadata of the object 122A indicates that the object 122A is of the background type, determines that the object 122A is of the background type. As another example, the location determination unit 170, in response to determining that metadata of the object 122B indicates that the object 122B is of the foreground type, determines that the object 122B is of the foreground type and not of the background type.

The method 300 includes, in response to determining that the object is of the background type, at 314, inserting the object in the background, at 316. For example, the object insertion unit 116 of FIG. 1, in response to determining that a first insertion location 164 (e.g., background) is designated for the object 122A of the one or more objects 182, inserts the object 122A at the first insertion location (e.g., background) in one or more video frames of the video stream 136, as described with reference to FIG. 1.

Otherwise, in response to determining that the object is not of the background type, at 314, the method 300 includes inserting the object in the foreground, at 318. For example, the object insertion unit 116 of FIG. 1, in response to determining that a second insertion location 164 (e.g., foreground) is designated for the object 122B of the one or more objects 182, inserts the object 122B at the second insertion location (e.g., foreground) in one or more video frames of the video stream 136, as described with reference to FIG. 1.

The method 300 thus enables generating new objects 122 associated with the one or more detected keywords 180 when none of the pre-existing objects 122 are associated with the one or more detected keywords 180. An object 122 can be added to the background or the foreground of the video stream 136 based on an object type of the object 122. The object type of the object 122 can be based on a file type, a storage location, metadata, or a combination thereof, of the object 122.

In the diagram 350, the keyword detection unit 112 uses the keyword detection neural network 160 to process the audio stream 134 to determine the one or more detected keywords 180 (e.g., “New York City”). In a particular aspect, the adaptive classifier 144 determines that the object 122A (e.g., an image of the Statue of Liberty) is associated with the one or more detected keywords 180 (e.g., “New York City”) and adds the object 122A to the one or more objects 182. The location determination unit 170, in response to determining that the object 122A is of a background type, designates the object 122A as associated with a first insertion location 164 (e.g., background). The object insertion unit 116, in response to determining that the object 122A is associated with the first insertion location 164 (e.g., background), inserts the object 122A in one or more video frames of a video stream 136A to generate a video stream 136B.

According to an alternative aspect, the adaptive classifier 144 may instead determine that the object 122B (e.g., clip art of an apple with the letters “NY”) is associated with the one or more detected keywords 180 (e.g., “New York City”) and adds the object 122B to the one or more objects 182. The location determination unit 170, in response to determining that the object 122B is not of the background type, designates the object 122B as associated with a second insertion location 164 (e.g., foreground). The object insertion unit 116, in response to determining that the object 122B is associated with the second insertion location 164 (e.g., foreground), inserts the object 122B in one or more video frames of a video stream 136A to generate a video stream 136C.

Referring to FIG. 4, a diagram 400 of an illustrative implementation of the keyword detection unit 112 is shown. The keyword detection neural network 160 includes a speech recognition neural network 460 coupled via a potential keyword detector 462 to a keyword selector 464.

The speech recognition neural network 460 is configured to process at least a portion of the audio stream 134 to generate one or more words 461 that are detected in the portion of the audio stream 134. In a particular aspect, the speech recognition neural network 460 includes a recurrent neural network (RNN). In other aspects, the speech recognition neural network 460 can include another type of neural network.

In an illustrative implementation, the speech recognition neural network 460 includes an encoder 402, a RNN transducer (RNN-T) 404, and a decoder 406. In a particular aspect, the encoder 402 is trained as a connectionist temporal classification (CTC) network. During training, the encoder 402 is configured to process one or more acoustic features 412 to predict phonemes 414, graphemes 416, and wordpieces 418 from long short-term memory (LSTM) layers 420, LSTM layers 422, and LSTM layers 426, respectively. The encoder 402 includes a time convolutional layer 424 that reduces the encoder time sequence length (e.g., by a factor of three). The decoder 406 is trained to predict one or more wordpieces 458 by using LSTM layers 456 to process input embeddings 454 of one or more input wordpieces 452. According to some aspects, the decoder 406 is trained to reduce a cross-entropy loss.

The RNN-T 404 is configured to process one or more acoustic features 432 of at least a portion of the audio stream 134 using LSTM layers 434, LSTM layers 436, and LSTM layers 440 to provide a first input (e.g., a first wordpiece) to a feed forward 448 (e.g., a feed forward layer). The RNN-T 404 also includes a time convolutional layer 438. The RNN-T 404 is configured to use LSTM layers 446 to process input embeddings 444 of one or more input wordpieces 442 to provide a second input (e.g., a second wordpiece) to the feed forward 448. In a particular aspect, the one or more acoustic features 432 corresponds to real-time test data, and the one or more input wordpieces 442 correspond to existing training data on which the speech recognition neural network 460 is trained. The feed forward 448 is configured to process the first input and the second input to generate a wordpiece 450. The speech recognition neural network 460 is configured to output one or more words 461 corresponding to one or more wordpieces 450.

The RNN-T 404 is (e.g., weights of the RNN-T 404 are) initialized based on the encoder 402 (e.g., trained encoder 402) and the decoder 406 (e.g., trained decoder 406). In an example (indicated by dashed line arrows in FIG. 4), weights of the LSTM layers 434 are initialized based on weights of the LSTM layers 420, weights of the LSTM layers 436 are initialized based on weights of the LSTM layers 422, weights of the LSTM layers 440 are initialized based on the weights of the LSTM layers 426, weights of the time convolutional layer 438 are initialized based on weights of the time convolutional layer 424, weights of the LSTM layers 446 are initialized based on weights of the LSTM layers 456, weights to generate the input embeddings 444 are initialized based on weights to generate the input embeddings 454, or a combination thereof.

The LSTM layers 420 including 5 LSTM layers, the LSTM layers 422 including 5 LSTM layers, the LSTM layers 426 including 2 LSTM layers, and the LSTM layers 456 including 2 LSTM layers is provided as an illustrative example. In other examples, the LSTM layers 420, the LSTM layers 422, the LSTM layers 426, and the LSTM layers 456 can include any count of LSTM layers. In a particular aspect, the LSTM layers 434, the LSTM layers 436, the LSTM layers 440, and the LSTM layers 446 include the same count of LSTM layers as the LSTM layers 420, the LSTM layers 422, the LSTM layers 426, and the LSTM layers 456, respectively.

The potential keyword detector 462 is configured to process the one or more words 461 to determine one or more potential keywords 463, as further described with reference to FIG. 5. The keyword selector 464 is configured to select the one or more detected keywords 180 from the one or more potential keywords 463, as further described with reference to FIG. 5.

Referring to FIG. 5, a diagram 500 is shown of an illustrative aspect of operations associated with keyword detection. In a particular aspect, the keyword detection is performed by the keyword detection neural network 160, the keyword detection unit 112, the video stream updater 110, the one or more processors 102, the device 130, the system 100 of FIG. 1, the speech recognition neural network 460, the potential keyword detector 462, the keyword selector 464 of FIG. 4, or a combination thereof.

The keyword detection neural network 160 obtains at least a portion of an audio stream 134 representing speech. The keyword detection neural network 160 uses the speech recognition neural network 460 on the portion of the audio stream 134 to detect one or more words 461 (e.g., “A wish for you on your birthday, whatever you ask may you receive, whatever you wish may it be fulfilled on your birthday and always happy birthday”) of the speech, as described with reference to FIG. 4.

The potential keyword detector 462 performs semantic analysis on the one or more words 461 to identify one or more potential keywords 463 (e.g., “wish,” “ask,” “birthday”). For example, the potential keyword detector 462 disregards conjunctions, articles, prepositions, etc. in the one or more words 461. The one or more potential keywords 463 are indicated with underline in the one or more words 461 in the diagram 500. In some implementations, the one or more potential keywords 463 can include one or more words (e.g., “Wish,” “Ask,” “Birthday”), one or more phrases (e.g., “New York City,” “Alarm Clock”), or a combination thereof.

The keyword selector 464 selects at least one of the one or more potential keywords 463 (e.g., “Wish,” “Ask,” “Birthday”) as the one or more detected keywords 180 (e.g., “birthday”). In some implementations, the keyword selector 464 performs semantic analysis on the one or more words 461 to determine which of the one or more potential keywords 463 corresponds to a topic of the one or more words 461 and selects at least one of the one or more potential keywords 463 corresponding to the topic as the one or more detected keywords 180. In a particular example, the keyword selector 464, based at least in part on determining that a potential keyword 463 (e.g., “Birthday”) appears more frequently (e.g., three times) in the one or more words 461 as compared to others of the one or more potential keywords 463, selects the potential keyword 463 (e.g., “Birthday”) as the one or more detected keywords 180. The keyword selector 464 selects at least one (e.g., “Birthday”) of the one or more potential keywords 463 (e.g., “Wish,” “Ask,” “Birthday”) corresponding to the topic of the one or more words 461 as the one or more detected keywords 180.

In a particular aspect, an object 122A (e.g., clip art of a genie) is associated with one or more keywords 120A (e.g., “Wish” and “Genie”), and an object 122B (e.g., an image with balloons and a birthday banner) is associated with one or more keywords 120B (e.g., “Balloons,” “Birthday,” “Birthday Banner”). In a particular aspect, the adaptive classifier 144, in response to determining that the one or more keywords 120B (e.g., “Balloons,” “Birthday,” “Birthday Banner”) match the one or more detected keywords 180 (e.g., “Birthday”), selects the object 122B to include in one or more objects 182 associated with the one or more detected keywords 180, as described with reference to FIG. 1.

Referring to FIG. 6, a method 600, an example 650, an example 652, and an example 654 of object generation are shown. In a particular aspect, one or more operations of the method 600 are performed by the object generation neural network 140, the adaptive classifier 144, the video stream updater 110, the one or more processors 102, the device 130, the system 100 of FIG. 1, or a combination thereof.

The method 600 includes pre-processing, at 602. For example, the object generation neural network 140 of FIG. 1 pre-processes at least a portion of the audio stream 134. To illustrate, the pre-processing can include reducing noise in at least the portion of the audio stream 134 to increase a signal-to-noise ratio.

The method 600 also includes feature extraction, at 604. For example, the object generation neural network 140 of FIG. 1 extracts features 605 (e.g., acoustic features) from the pre-processed portions of the audio stream 134.

The method 600 further includes performing semantic analysis using a language model, at 606. For example, the object generation neural network 140 of FIG. 1 may obtain the one or more words 461 and one or more detected keywords 180 corresponding to the pre-processed portions of the audio stream 134. To illustrate, the object generation neural network 140 obtains the one or more words 461 based on operation of the keyword detection unit 112. For example, the keyword detection unit 112 of FIG. 1 performs pre-processing (e.g., de-noising, one or more additional enhancements, or a combination thereof) of at least a portion of the audio stream 134 to generate a pre-processed portion of the audio stream 134. The speech recognition neural network 460 of FIG. 4 performs speech recognition on the pre-processed portion to generate the one or more words 461 and may provide the one or more words 461 to the potential keyword detector 462 of FIG. 4 and also to the object generation neural network 140.

The object generation neural network 140 may perform semantic analysis on the features 605, the one or more words 461 (e.g., “a flower with long pink petals and raised orange stamen”), the one or more detected keywords 180 (e.g., “flower”), or a combination thereof, to generate one or more descriptors 607 (e.g., “long pink petals; raised orange stamen”). In a particular aspect, the object generation neural network 140 performs the semantic analysis using a language model. In some examples, the object generation neural network 140 performs the semantic analysis on the one or more detected keywords 180 (e.g., “New York”) to determine one or more related words (e.g., “Statue of Liberty,” “Harbor,” etc.).

The method 600 also includes generating an object using an object generation network, at 608. For example, the adaptive classifier 144 of FIG. 1 uses the object generation neural network 140 to process the one or more detected keywords 180 (e.g., “flower”), the one or more descriptors 607 (e.g., “long pink petals” and “raised orange stamen”), the related words, or a combination thereof, to generate the one or more objects 182, as further described with reference to FIG. 7. Thus, the adaptive classifier 144 enables multiple words corresponding to the one or more detected keywords 180 to be used as input to the object generation neural network 140 (e.g., a GAN) to generate an object 182 (e.g., an image) related to the multiple words. In some aspects, the object generation neural network 140 generates the object 182 (e.g., the image) in real-time as the audio stream 134 of a live media stream is being processed, so that the object 182 can be inserted in the video stream 136 at substantially the same time as the one or more detected keywords 180 are determined (e.g., with imperceptible or barely perceptible delay). Optionally, in a particular implementation, the object generation neural network 140 selects an existing object (e.g., an image of a flower) that matches the one or more detected keywords 180 (e.g., “flower”), and modifies the existing object to generate an object 182. For example, the object generation neural network 140 modifies the existing object based on the one or more detected keywords 180 (e.g., “flower”), the one or more descriptors 607 (e.g., “long pink petals” and “raised orange stamen”), the related words, or a combination thereof, to generate the object 182.

In the example 650, the adaptive classifier 144 uses the object generation neural network 140 to process the one or more words 461 (e.g., “A flower with long pink petals and raised orange stamen”) to generate objects 122 (e.g., generated images of flowers with various pink petals, orange stamens, or a combination thereof). In the example 652, the adaptive classifier 144 uses the object generation neural network 140 to process one or more words 461 (“Blue bird”) to generate an object 122 (e.g., a generated photo-realistic image of birds). In the example 654, the adaptive classifier 144 uses the object generation neural network 140 to process one or more words 461 (“Blue bird”) to generate an object 122 (e.g., generated clip art of a bird).

Referring to FIG. 7, a diagram 700 of an example of one or more components of the object determination unit 114 is shown and includes the object generation neural network 140. In a particular aspect, the object determination unit 114 can include one or more additional components that are not shown for ease of illustration.

In a particular implementation, the object generation neural network 140 includes stacked GANs. To illustrate, the object generation neural network 140 includes a stage-1 GAN coupled to a stage-2 GAN. The stage-1 GAN includes a conditioning augmentor 704 coupled via a stage-1 generator 706 to a stage-1 discriminator 708. The stage-2 GAN includes a conditioning augmentor 710 coupled via a stage-2 generator 712 to a stage-2 discriminator 714. The stage-1 GAN generates a lower-resolution object based on an embedding 702. The stage-2 GAN generates a higher-resolution object (e.g., a photo-realistic image) based on the embedding 702 and also based on the lower-resolution object from the stage-1 GAN.

The object generation neural network 140 is configured to generate an embedding (φₜ) 702 of a text description 701 (e.g., “The bird is grey with white on the chest and has very short beak”) representing at least a portion of the audio stream 134. In some aspects, the text description 701 corresponds to the one or more words 461 of FIG. 4, the one or more detected keywords 180 of FIG. 1, the one or more descriptors 607 of FIG. 6, related words, or a combination thereof. In particular implementations, some details of the text description 701 that are disregarded by the stage-1 GAN in generating the lower-resolution object are considered by the stage-2 GAN in generating the higher-resolution object.

The object generation neural network 140 provides the embedding 702 to each of the conditioning augmentor 704, the stage-1 discriminator 708, the conditioning augmentor 710, and the stage-2 discriminator 714. The conditioning augmentor 704 processes the embedding (φₜ) 702 using a fully connected layer to generate a mean (μ₀) 703 and variance (σ₀) 705 for a Gaussian distribution N(μ₀(φₜ), Σ₀(φₜ)), where Σ₀ (φₜ) corresponds to a diagonal covariance matrix that is a function of the embedding (φₜ) 702. The variance (σ₀) 705 correspond to values in the diagonal of Σ₀ (φₜ). The conditioning augmentor 704 generates Gaussian conditioning variables (ĉ₀) 709 for the embedding 702 sampled from the Gaussian distribution N(μ₀(φₜ), Σ₀(φₜ)) to capture the meaning of the embedding 702 with variations. For example, the conditioning variables (ĉ₀) 709 are based on the following Equation:

ĉ₀=μ₀+σ₀⊙ϵ,Equation 1
where ĉ₀ corresponds to the conditioning variables (ĉ₀) 709 (e.g., a conditioning vector), μ₀ corresponds to the mean (μ₀) 703, σ₀ corresponds to the variance (σ₀) 705, ⊙ corresponds to element-wise multiplication, C corresponds to the Gaussian distribution N(0, 1). The conditioning augmentor 704 provides the conditioning variables (ĉ₀) 709 (e.g., a conditioning vector) to the stage-1 generator 706.

The stage-1 generator 706 generates a lower-resolution object 717 conditioned on the text description 701. For example, the stage-1 generator 706, conditioned on the conditioning variables (ĉ₀) 709 and a random variable (z), generates the lower-resolution object 717. In an example, the lower-resolution object 717 (e.g., an image, clip art, GIF file, etc.) represents primitive shapes and basic colors. In a particular aspect, the random variable (z) corresponds to random noise (e.g., a dimensional noise vector). In a particular example, the stage-1 generator 706 concatenates the conditioning variables (ĉ₀) 709 and the random variable (z), and the concatenation is processed by a series of upsampling blocks 715 to generate the lower-resolution object 717.

The stage-1 discriminator 708 spatially replicates a compressed version of the embedding (φₜ) 702 to generate a text tensor. The stage-1 discriminator 708 uses downsampling blocks 719 to process the lower-resolution object 717 to generate an object filter map. The object filter map is concatenated with the text tensor to generate an object text tensor that is fed to a convolutional layer. A fully connected layer 721 with one node is used to produce a decision score.

In some aspects, the stage-2 generator 712 is designed as an encoder-decoder with residual blocks 729. Similar to the conditioning augmentor 704, the conditioning augmentor 710 processes the embedding (φₜ) 702 to generate conditioning variables (ĉ₀) 723, which are spatially replicated at the stage-2 generator 712 to form a text tensor. The lower-resolution object 717 is processed by a series of downsampling blocks (e.g., encoder) to generate an object filter map. The object filter map is concatenated with the text tensor to generate an object text tensor that is processed by the residual blocks 729. In a particular aspect, the residual blocks 729 are designed to learn multi-model representations across features of the lower-resolution object 717 and features of the text description 701. A series of upsampling blocks 731 (e.g., decoder) are used to generate a higher-resolution object 733. In a particular example, the higher-resolution object 733 corresponds to a photo-realistic image.

The stage-2 discriminator 714 spatially replicates a compressed version of the embedding (φₜ) 702 to generate a text tensor. The stage-2 discriminator 714 uses downsampling blocks 735 to process the higher-resolution object 733 to generate an object filter map. In a particular aspect, because of a larger size of the higher-resolution object 733 as compared to the lower-resolution object 717, a count of the downsampling blocks 735 is greater than a count of the downsampling blocks 719. The object filter map is concatenated with the text tensor to generate an object text tensor that is fed to a convolutional layer. A fully connected layer 737 with one node is used to produce a decision score.

During a training phase, the stage-1 generator 706 and the stage-1 discriminator 708 may be jointly trained. During training, the stage-1 discriminator 708 is trained (e.g., modified based on feedback) to improve its ability to distinguish between images generated by the stage-1 generator 706 and real images having similar resolution, while the stage-1 generator 706 is trained to improve its ability to generate images that the stage-1 discriminator 708 classifies as real images. Similarly, the stage-2 generator 712 and the stage-2 discriminator 714 may be jointly trained. During training, the stage-2 discriminator 714 is trained (e.g., modified based on feedback) to improve its ability to distinguish between images generated by the stage-2 generator 712 and real images having similar resolution, while the stage-2 generator 712 is trained to improve its ability to generate images that the stage-2 discriminator 714 classifies as real images. In some implementations, after completion of the training phase, the stage-1 generator 706 and the stage-2 generator 712 can be used in the object generation neural network 140, while the stage-1 discriminator 708 and the stage-2 discriminator 714 can be omitted (or deactivated).

In a particular aspect, the lower-resolution object 717 corresponds to an image with basic colors and primitive shapes, and the higher-resolution object 733 corresponds to a photo-realistic image. In a particular aspect, the lower-resolution object 717 corresponds to a basic line drawing (e.g., without gradations in shade, monochromatic, or both), and the higher-resolution object 733 corresponds to a detailed drawing (e.g., with gradations in shade, multi-colored, or both).

In a particular aspect, the object determination unit 114 adds the higher-resolution object 733 as an object 122A to the database 150 and updates the object keyword data 124 to indicate that the object 122A is associated with one or more keywords 120A (e.g., the text description 701). In a particular aspect, the object determination unit 114 adds the lower-resolution object 717 as an object 122B to the database 150 and updates the object keyword data 124 to indicate that the object 122B is associated with one or more keywords 120B (e.g., the text description 701). In a particular aspect, the object determination unit 114 adds the lower-resolution object 717, the higher-resolution object 733, or both, to the one or more objects 182.

Referring to FIG. 8, a method 800 of object classification is shown. In a particular aspect, one or more operations of the method 800 are performed by the object classification neural network 142, the object determination unit 114, the adaptive classifier 144, the video stream updater 110, the one or more processors 102, the device 130, the system 100 of FIG. 1, or a combination thereof.

The method 800 includes picking a next object from a database, at 802. For example, the adaptive classifier 144 of FIG. 1 can select an initial object (e.g., an object 122A) from the database 150 during an initial iteration of a processing loop over all of the objects 122 in the database 150, as described further below.

The method 800 also includes determining whether the object is associated with any keyword, at 804. For example, the adaptive classifier 144 of FIG. 1 determines whether the object keyword data 124 indicates any keywords 120 associated with the object 122A.

The method 800 includes, in response to determining that the object is associated with at least one keyword, at 804, determining whether there are more objects in the database, at 806. For example, the adaptive classifier 144 of FIG. 1, in response to determining that the object keyword data 124 indicates that the object 122A is associated with one or more keywords 120A, determines whether there are any additional objects 122 in the database 150. To illustrate, the adaptive classifier 144 analyzes the objects 122 in order based on an object identifier and determines whether there are additional objects in the database 150 corresponding to a next identifier subsequent to an identifier of the object 122A. If there are no more unprocessed objects in the database, the method 800 ends, at 808. Otherwise, the method 800 includes selecting a next object from the database for a next iteration of the processing loop, at 802.

The method 800 includes, in response to determining that the object is not associated with any keyword, at 804, applying an object classification neural network to the object, at 810. For example, the adaptive classifier 144 of FIG. 1, in response to determining that the object keyword data 124 indicates that the object 122A is not associated with any keywords 120, applies the object classification neural network 142 to the object 122A to generate one or more potential keywords, as further described with reference to FIGS. 9A-9C.

The method 800 also includes associating the object with the generated potential keyword having the highest probable score, at 812. For example, each of the potential keywords generated by the object classification neural network 142 for an object may be associated with a score indicating a probability that the potential keyword matches the object. The adaptive classifier 144 can designate the keyword that has the highest score of the potential keywords as a keyword 120A and update the object keyword data 124 to indicate that the object 122A is associated with the keyword 120A, as further described with reference to FIG. 9C.

Referring to FIG. 9A, a diagram 900 is shown of an illustrative aspect of operations associated with the object classification neural network 142 of FIG. 1. The object classification neural network 142 is configured to perform feature extraction 902 on an object 122A to generate features 926, as further described with reference to FIG. 9B.

The object classification neural network 142 is configured to perform classification 904 of the features 926 to generate a classification layer output 932, as further described with reference to FIG. 9C. The object classification neural network 142 is configured to process the classification layer output 932 to determine a probability distribution 906 associated with one or more potential keywords and to select, based on the probability distribution 906, at least one of the one or more potential keywords as the one or more keywords 120A.

Referring to FIG. 9B, a diagram is shown of an illustrative aspect of the feature extraction 902. In a particular implementation, the object classification neural network 142 includes a convolutional neural network (CNN) that includes multiple convolution stages 922 that are configured to generate an output feature map 924. The convolution stages 922 include a first set of convolution, ReLU, and pooling layers of a first stage 922A, a second set of convolution, ReLU, and pooling layers of a second stage 922B, and a third set of convolution, ReLU, and pooling layers of a third stage 922C. The output feature map 924 output from the third stage 922C is converted to a vector (e.g., a flatten layer) corresponding to features 926. Although three convolution stages 922 are illustrated, in other implementations any other number of convolution stages 922 may be used for feature extraction.

Referring to FIG. 9C, a diagram is shown of an illustrative aspect of the classification 904 and determining the probability distribution 906. In a particular aspect, the object classification neural network 142 includes fully connected layers 928, such as a layer 928A, a layer 928B, a layer 928C, one or more additional layers, or a combination thereof. The object classification neural network 142 performs the classification 904 by using the fully connected layers 928 to process the features 926 to generate a classification layer output 932. For example, an output of a last layer 928D corresponds to the classification layer output 932.

The object classification neural network 142 applies a softmax activation function 930 to the classification layer output 932 to generate the probability distribution 906. For example, the probability distribution 906 indicates probabilities of one or more potential keywords 934 being associated with the object 122A. To illustrate, the probability distribution 906 indicates a first probability (e.g., 0.5), a second probability (e.g., 0.7), and a third probability (e.g., 0.1) of a first potential keyword 934 (e.g., “bird”), a second potential keyword 934 (e.g., “blue bird”), and a third potential keyword 934 (e.g., “white bird”), respectively, of being associated with the object 122A (e.g., an image of blue birds).

The object classification neural network 142 selects, based on the probability distribution 906, at least one of the one or more potential keywords 934 to include in one or more keywords 120A associated with the object 122A (e.g., an image of blue birds). In the illustrated example, the object classification neural network 142 selects the second potential keyword 934 (e.g., “blue bird”) in response to determining that the second potential keyword 934 (e.g., “blue bird”) is associated with the highest probability (e.g., 0.7) in the probability distribution 906. In another implementation, the object classification neural network 142 selects at least one of the potential keywords 934 based on the selected one or more potential keywords having at least a threshold probability (e.g., 0.5) as indicated by the probability distribution 906. For example, the object classification neural network 142, in response to determining that each of the first potential keyword 934 (e.g., “bird”) and the second potential keyword 934 (e.g., “blue bird”) is associated with the first probability (e.g., 0.5) and the second probability (e.g., 0.7), respectively, that is greater than or equal to a threshold probability (e.g., 0.5), selects the first potential keyword 934 (e.g., “bird”) and the second potential keyword 934 (e.g., “blue bird”) to include in the one or more keywords 120A.

Referring to FIG. 10A, a method 1000 and an example 1050 of insertion location determination are shown. In a particular aspect, one or more operations of the method 1000 are performed by the location neural network 162, the location determination unit 170, the object insertion unit 116, the video stream updater 110, the one or more processors 102, the device 130, the system 100 of FIG. 1, or a combination thereof.

The method 1000 includes applying a location neural network to a video frame, at 1002. In an example 1050, the location determination unit 170 applies the location neural network 162 to a video frame 1036 of the video stream 136 to generate features 1046, as further described with reference to FIG. 10B.

The method 1000 also includes performing segmentation, at 1022. For example, the location determination unit 170 performs segmentation based on the features 1046 to generate one or more segmentation masks 1048. In some aspects, performing the segmentation includes applying a neural network to the features 1046 according to various techniques to generate the segment masks. Each segmentation mask 1048 corresponds to an outline of a segment of the video frame 1036 that corresponds to a region of interest, such as a person, a shirt, pants, a cap, a picture frame, a television, a sports field, one or more other types of regions of interest, or a combination thereof.

The method 1000 further includes applying masking, at 1024. For example, the location determination unit 170 applies the one or more segmentation masks 1048 to the video frame 1036 to generate one or more segments 1050. To illustrate, the location determination unit 170 applies a first segmentation mask 1048 to the video frame 1036 to generate a first segment corresponding to a shirt, applies a second segmentation mask 1048 to the video frame 1036 to generate a second segment corresponding to pants, and so on.

The method 1000 also includes applying detection, at 1026. For example, the location determination unit 170 performs detection to determine whether any of the one or more segments 1050 match a location criterion. To illustrate, the location criterion can indicate valid insertion locations for the video stream 136, such as person, shirt, playing field, etc. In some examples, the location criterion is based on default data, a configuration setting, a user input, or a combination thereof. The location determination unit 170 generates detection data 1052 indicating whether any of the one or more segments 1050 match the location criterion. In a particular aspect, the location determination unit 170, in response to determining that at least one segment of the one or more segments 1050 matches the location criterion, generates the detection data 1052 indicating the at least one segment.

Optionally, in some implementations, the method 1000 includes applying detection for each of the one or more objects 182 based on object type of the one or more objects 182. For example, the one or more objects 182 include an object 122A that is of a particular object type. In some implementations, the location criterion indicates valid locations associated with object type. For example, the location criterion indicates first valid locations (e.g., shirt, cap, etc.) associated with a first object type (e.g., GIF, clip art, etc.), second valid locations (e.g., wall, playing field, etc.) associated with a second object type (e.g., image), and so on. The location determination unit 170, in response to determining that the object 122A is of the first object type, generates the detection data 1052 indicating at least one of the one or more segments 1050 that matches the first valid locations. Alternatively, the location determination unit 170, in response to determining that the object 122A is of the second object type, generates the detection data 1052 indicating at least one of the one or more segments 1050 that matches the second valid locations.

In some implementations, the location criterion indicates that, if the one or more objects 182 include an object 122 associated with a keyword 120 and another object associated with the keyword 120 is included in a background of a video frame, the object 122 is to be included in the foreground of the video frame. For example, the location determination unit 170, in response to determining that the one or more objects 182 include an object 122A associated with one or more keywords 120A, that the video frame 1036 includes an object 122B associated with one or more keywords 120B in a first location (e.g., background), and that at least one of the one or more keywords 120A matches at least one of the one or more keywords 120B, generates the detection data 1052 indicating at least one of the one or more segments 1050 that matches a second location (e.g., foreground) of the video frame 1036.

The method 1000 further includes determining whether a location is identified, at 1008. For example, the location determination unit 170 determines whether the detection data 1052 indicates that any of the one or more segments 1050 match the location criterion.

The method 1000 includes, in response to determining that the location is identified, at 1008, designating an insertion location, at 1010. In the example 1050, the location determination unit 170, in response to determining that the detection data 1052 indicates that a segment 1050 (e.g., a shirt) satisfies the location criterion, designates the segment 1050 as an insertion location 164. In a particular example, the detection data 1052 indicates that multiple segments 1050 satisfy the location criterion. In some aspects, the location determination unit 170 selects one of the multiple segments 1050 to designate as the insertion location 164. In other examples, the location determination unit 170 selects two or more (e.g., all) of the multiple segments 1050 to add to the one or more insertion locations 164.

The method 1000 includes, in response to determining that no location is identified, at 1008, skipping insertion, at 1012. For example, the location determination unit 170, in response to determining that the detection data 1052 indicates that none of the segments 1050 match the location criterion, generates a “no location” output indicating that no insertion locations are selected. In this example, the object insertion unit 116, in response to receiving the no location output, outputs the video frame 1036 without inserting any objects in the video frame 1036.

Referring to FIG. 10B, a diagram 1070 is shown of an illustrative aspect of operations performed by the location neural network 162 of the location determination unit 170. In a particular aspect, the location neural network 162 includes a residual neural network (resnet), such as resnet 152. For example, the location neural network 162 includes a plurality of convolution layers (e.g., CONV1, CONV2, etc.) and a pooling layer (“POOL”) that are used to process the video frame 1036 to generate the features 1046.

Referring to FIG. 11, a diagram of a system 1100 that includes a particular implementation of the device 130 is shown. The system 1100 is operable to perform keyword-based object insertion into a video stream. In a particular aspect, the system 100 of FIG. 1 includes one or more components of the system 1100. Some components of the device 130 of FIG. 1 are not shown in the device 130 of FIG. 11 for ease of illustration. In some aspects, the device 130 of FIG. 1 can include one or more of the components of the device 130 that are shown in FIG. 11, one or more additional components, one or more fewer components, one or more different components, or a combination thereof.

The system 1100 includes the device 130 coupled to a device 1130 and to one or more display devices 1114. In a particular aspect, the device 1130 includes a computing device, a server, a network device, a storage device, a cloud storage device, a video camera, a communication device, a broadcast device, or a combination thereof. In a particular aspect, the one or more display devices 1114 includes a touch screen, a monitor, a television, a communication device, a playback device, a display screen, a vehicle, an XR device, or a combination thereof. In a particular aspect, an XR device can include an augmented reality device, a mixed reality device, or a virtual reality device. The one or more display devices 1114 are described as external to the device 130 as an illustrative example. In other examples, the one or more display devices 1114 can be integrated in the device 130.

The device 130 includes a demultiplexer (demux) 1172 coupled to the video stream updater 110. The device 130 is configured to receive a media stream 1164 from the device 1130. In an example, the device 130 receives the media stream 1164 via a network from the device 1130. The network can include a wired network, a wireless network, or both.

The demux 1172 demultiplexes the media stream 1164 to generate the audio stream 134 and the video stream 136. The demux 1172 provides the audio stream 134 to the keyword detection unit 112 and provides the video stream 136 to the location determination unit 170, the object insertion unit 116, or both. The video stream updater 110 updates the video stream 136 by inserting one or more objects 182 in one or more portions of the video stream 136, as described with reference to FIG. 1.

In a particular aspect, the media stream 1164 corresponds to a live media stream. The video stream updater 110 updates the video stream 136 of the live media stream and provides to the video stream 136 (e.g., the updated version of the video stream 136) to one or more display devices 1114, one or more storage devices, or a combination thereof.

In some examples, the video stream updater 110 selectively updates a first portion of the video stream 136, as described with reference to FIG. 1. The video stream updater 110 provides the first portion (e.g., subsequent to the selective update) to the one or more display devices 1114, one or more storage devices, or a combination thereof. Optionally, in some aspects, the device 130 outputs updated portions of the video stream 136 to the one or more display devices 1114 while receiving subsequent portions of the video stream 136 included in the media stream 1164 from the device 1130. Optionally, in some aspects, the video stream updater 110 provides the audio stream 134 to one or more speakers concurrently with providing the video stream 136 to the one or more display devices 1114.

Referring to FIG. 12, a diagram of a system 1200 is shown. The system 1200 is operable to perform keyword-based object insertion into a video stream. The system 1200 includes the device 130 coupled to a device 1206 and to the one or more display devices 1114.

In a particular aspect, the device 1206 includes a computing device, a server, a network device, a storage device, a cloud storage device, a video camera, a communication device, a broadcast device, or a combination thereof. The device 130 includes a decoder 1270 coupled to the video stream updater 110 and configured to receive encoded data 1262 from the device 1206. In an example, the device 130 receives the encoded data 1262 via a network from the device 1206. The network can include a wired network, a wireless network, or both.

The decoder 1270 decodes the encoded data 1262 to generate decoded data 1272. In a particular aspect, the decoded data 1272 includes the audio stream 134 and the video stream 136. In a particular aspect, the decoded data 1272 includes one of the audio stream 134 or the video stream 136. In this aspect, the video stream updater 110 obtains the decoded data 1272 (e.g., one of the audio stream 134 or the video stream 136) from the decoder 1270 and obtains the other of the audio stream 134 or the video stream 136 separately from the decoded data 1272, such as from another component or device. The video stream updater 110 selectively updates the video stream 136, as described with reference to FIG. 1, and provides the video stream 136 (e.g., subsequent to the selective update) to the one or more display devices 1114, one or more storage devices, or a combination thereof.

Referring to FIG. 13, a diagram of a system 1300 is shown. The system 1300 is operable to perform keyword-based object insertion into a video stream. The system 1300 includes the device 130 coupled to one or more microphones 1302 and to the one or more display devices 1114.

The one or more microphones 1302 are shown as external to the device 130 as an illustrative example. In other examples, the one or more microphones 1302 can be integrated in the device 130. The video stream updater 110 receives an audio stream 134 from the one or more microphones 1302 and obtains the video stream 136 separately from the audio stream 134. In a particular aspect, the audio stream 134 includes speech of a user. The video stream updater 110 selectively updates the video stream 136, as described with reference to FIG. 1, and provides the video stream 136 to the one or more display devices 1114. In a particular aspect, the video stream updater 110 provides the video stream 136 to display screens of one or more authorized devices (e.g., the one or more display devices 1114). For example, the device 130 captures speech of a performer while the performer is backstage at a concert and sends enhanced video content (e.g., the video stream 136) to devices of premium ticket holders.

Referring to FIG. 14, a diagram of a system 1400 is shown. The system 1400 is operable to perform keyword-based object insertion into a video stream. The system 1400 includes the device 130 coupled to one or more cameras 1402 and to the one or more display devices 1114.

The one or more cameras 1402 are shown as external to the device 130 as an illustrative example. In other examples, the one or more cameras 1402 can be integrated in the device 130. The video stream updater 110 receives the video stream 136 from the one or more cameras 1402 and obtains the audio stream 134 separately from the video stream 136. The video stream updater 110 selectively updates the video stream 136, as described with reference to FIG. 1, and provides the video stream 136 to the one or more display devices 1114.

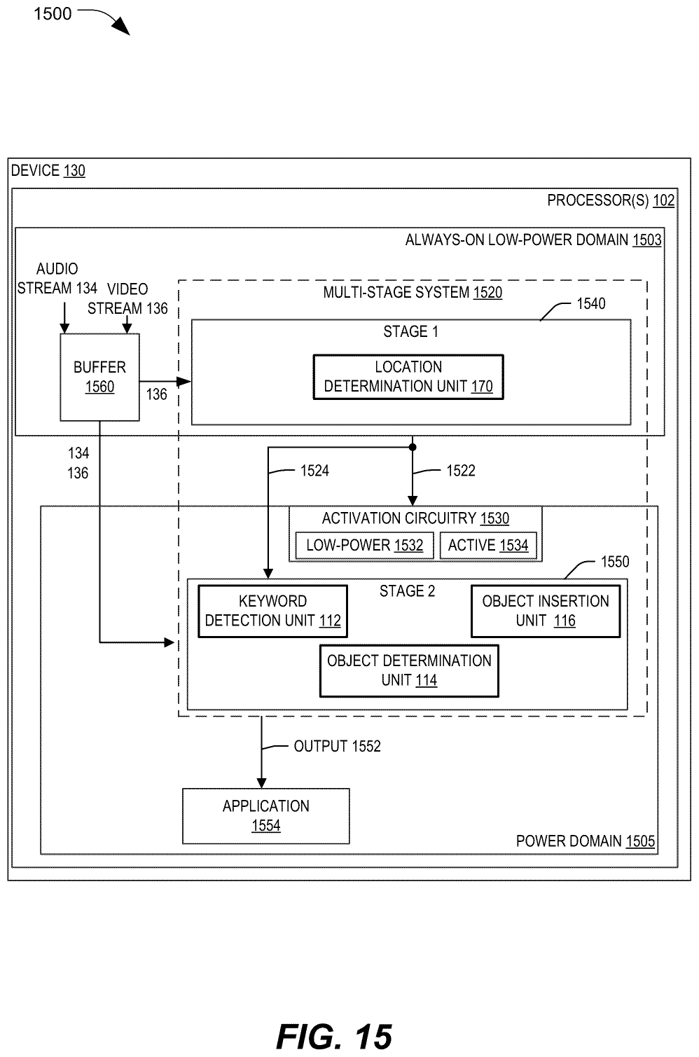

FIG. 15 is a block diagram of an illustrative aspect of a system 1500 operable to perform keyword-based object insertion into a video stream, in accordance with some examples of the present disclosure, in which the one or more processors 102 includes an always-on power domain 1503 and a second power domain 1505, such as an on-demand power domain. In some implementations, a first stage 1540 of a multi-stage system 1520 and a buffer 1560 are configured to operate in an always-on mode, and a second stage 1550 of the multi-stage system 1520 is configured to operate in an on-demand mode.

The always-on power domain 1503 includes the buffer 1560 and the first stage 1540. Optionally, in some implementations, the first stage 1540 includes the location determination unit 170. The buffer 1560 is configured to store at least a portion of the audio stream 134 and at least a portion of the video stream 136 to be accessible for processing by components of the multi-stage system 1520. For example, the buffer 1560 stores one or more portions of the audio stream 134 to be accessible for processing by components of the second stage 1550 and stores one or more portions of the video stream 136 to be accessible for processing by components of the first stage 1540, the second stage 1550, or both.

The second power domain 1505 includes the second stage 1550 of the multi-stage system 1520 and also includes activation circuitry 1530. Optionally, in some implementations, the second stage 1550 includes the keyword detection unit 112, the object determination unit 114, the object insertion unit 116, or a combination thereof.

The first stage 1540 of the multi-stage system 1520 is configured to generate at least one of a wakeup signal 1522 or an interrupt 1524 to initiate one or more operations at the second stage 1550. In an example, the wakeup signal 1522 is configured to transition the second power domain 1505 from a low-power mode 1532 to an active mode 1534 to activate one or more components of the second stage 1550.

For example, the activation circuitry 1530 may include or be coupled to power management circuitry, clock circuitry, head switch or foot switch circuitry, buffer control circuitry, or any combination thereof. The activation circuitry 1530 may be configured to initiate powering-on of the second stage 1550, such as by selectively applying or raising a voltage of a power supply of the second stage 1550, of the second power domain 1505, or both. As another example, the activation circuitry 1530 may be configured to selectively gate or un-gate a clock signal to the second stage 1550, such as to prevent or enable circuit operation without removing a power supply.

In some implementations, the first stage 1540 includes the location determination unit 170 and the second stage 1550 includes the keyword detection unit 112, the object determination unit 114, the object insertion unit 116, or a combination thereof. In these implementations, the first stage 1540 is configured to, responsive to the location determination unit 170 detecting at least one insertion location 164, generate at least one of the wakeup signal 1522 or the interrupt 1524 to initiate operations of the keyword detection unit 112 of the second stage 1550.

In some implementations, the first stage 1540 includes the keyword detection unit 112 and the second stage 1550 includes the location determination unit 170, the object determination unit 114, the object insertion unit 116, or a combination thereof. In these implementations, the first stage 1540 is configured to, responsive to the keyword detection unit 112 determining the one or more detected keywords 180, generate at least one of the wakeup signal 1522 or the interrupt 1524 to initiate operations of the location determination unit 170, the object determination unit 114, or both, of the second stage 1550.

An output 1552 generated by the second stage 1550 of the multi-stage system 1520 is provided to an application 1554. The application 1554 may be configured to output the video stream 136 to one or more display devices, the audio stream 134 to one or more speakers, or both. To illustrate, the application 1554 may correspond to a voice interface application, an integrated assistant application, a vehicle navigation and entertainment application, a gaming application, a social networking application, or a home automation system, as illustrative, non-limiting examples.

By selectively activating the second stage 1550 based on a result of processing data at the first stage 1540 of the multi-stage system 1520, overall power consumption associated keyword-based object insertion into a video stream may be reduced.

Referring to FIG. 16, a diagram 1600 of an illustrative aspect of operation of components of the system 100 of FIG. 1, in accordance with some examples of the present disclosure. The keyword detection unit 112 is configured to receive a sequence 1610 of audio data samples, such as a sequence of successively captured frames of the audio stream 134, illustrated as a first frame (A1) 1612, a second frame (A2) 1614, and one or more additional frames including an Nth frame (AN) 1616 (where N is an integer greater than two). The keyword detection unit 112 is configured to output a sequence 1620 of sets of detected keywords 180 including a first set (K1) 1622, a second set (K2) 1624, and one or more additional sets including an Nth set (KN) 1626.

The object determination unit 114 is configured to receive the sequence 1620 of sets of detected keywords 180. The object determination unit 114 is configured to output a sequence 1630 of sets of one or more objects 182, including a first set (O1) 1632, a second set (O2) 1634, and one or more additional sets including an Nth set (ON) 1636.

The location determination unit 170 is configured to receive a sequence 1640 of video data samples, such as a sequence of successively captured frames of the video stream 136, illustrated as a first frame (V1) 1642, a second frame (V2) 1644, and one or more additional frames including an Nth frame (VN) 1646. The location determination unit 170 is configured to output a sequence 1650 of sets of one or more insertion locations 164, including a first set (L1) 1652, a second set (L2) 1654, and one or more additional sets including an Nth set (LN) 1656.

The object insertion unit 116 is configured to receive the sequence 1630, the sequence 1640, and the sequence 1650. The object insertion unit 116 is configured to output a sequence 1660 of video data samples, such as frames of the video stream 136, e.g., the first frame (V1) 1642, the second frame (V2) 1644, and one or more additional frames including the Nth frame (VN) 1646.

During operation, the keyword detection unit 112 processes the first frame 1612 to generate the first set 1622 of detected keywords 180. In some examples, the keyword detection unit 112, in response to determining that no keywords are detected in the first frame 1612, generates the first set 1622 (e.g., an empty set) indicating no keywords detected. The location determination unit 170 processes the first frame 1642 to generate the first set 1652 of insertion locations 164. In some examples, the location determination unit 170, in response to determining that no insertion locations are detected in the first frame 1642, generates the first set 1652 (e.g., an empty set) indicating insertion locations detected.

Optionally, in some aspects, the first frame 1612 is time-aligned with the first frame 1642. For example, a particular time (e.g., a capture time, a playback time, a receipt time, a creation time, etc.) indicated by a first timestamp associated with the first frame 1612 is within a threshold duration of a corresponding time of the first frame 1642.

The object determination unit 114 processes the first set 1622 of detected keywords 180 to generate the first set 1632 of one or more objects 182. In some examples, the object determination unit 114, in response to determining that the first set 1622 (e.g., an empty set) indicates no keywords detected, that there are no objects (e.g., no pre-existing objects and no generated objects) associated with the first set 1622, or both, generates the first set 1632 (e.g., an empty set) indicating that there are no objects associated with the first set 1622 of detected keywords 180.

The object insertion unit 116 processes the first frame 1642 of the video stream 136, the first set 1652 of the insertion locations 164, and the first set 1632 of the one or more objects 182 to selectively update the first frame 1642. The sequence 1660 includes the selectively updated version of the first frame 1642. As an example, the object insertion unit 116, in response to determining that the first set 1652 (e.g., an empty set) indicates no insertion locations detected, that the first set 1632 (e.g., an empty set) indicates no objects (e.g., no pre-existing objects and no generated objects), or both, adds the first frame 1642 (without inserting any objects) to the sequence 1660. Alternatively, when the first set 1632 includes one or more objects and the first set 1652 indicates one or more insertion locations 164, the object insertion unit 116 inserts one or more objects of the first set 1632 at the one or more insertion locations 164 indicated by the first set 1652 to update the first frame 1642 and adds the updated version of the first frame 1642 in the sequence 1660.

Optionally, in some examples, the object insertion unit 116, responsive to updating the first frame 1642, updates one or more additional frames of the sequence 1640. For example, the first set 1632 of objects 182 can be inserted in multiple frames of the sequence 1640 so that the objects persist for more than a single video frame during playout. Optionally, in some aspects, the object insertion unit 116, responsive to updating the first frame 1642, instructs the keyword detection unit 112 to skip processing of one or more frames of the sequence 1610. For example, the one or more detected keywords 180 may remain the same for at least a threshold count of frames of the sequence 1610 so that updates to frames of the sequence 1660 correspond to the same keywords 180 for at least a threshold count of frames.

In an example, an insertion location 164 indicates a specific position in the first frame 1642, and generating the updated version of the first frame 1642 includes inserting at least one object of the first set 1632 at the specific position in the first frame 1642. In another example, an insertion location 164 indicates specific content (e.g., a shirt) represented in the first frame 1642. In this example, generating the updated version of the first frame 1642 includes performing image recognition to detect a position of the content (e.g., the shirt) in the first frame 1642 and inserting at least one object of the first set 1632 at the detected position in the first frame 1642. In some examples, an insertion location 164 indicates one or more particular image frames (e.g., a threshold count of image frames). To illustrate, responsive to updating the first frame 1642, the object insertion unit 116 selects up to the threshold count of image frames that are subsequent to the first frame 1642 in the sequence 1640 as one or more additional frames for insertion. Updating the one or more additional frames includes performing image recognition to detect a position of the content (e.g., the shirt) in each of the one or more additional frames. The object insertion unit 116, in response to determining that the content is detected in an additional frame, inserts the at least one object at a detected position of the content in the additional frame. Alternatively, the object insertion unit 116, in response to determining that the content is not detected in an additional frame, skips insertion in that additional frame and processes a next additional frame for insertion. To illustrate, the inserted object changes position as the content (e.g., the shirt) changes position in the additional frames and the object is not inserted in any of the additional frames in which the content is not detected.

Such processing continues, including the keyword detection unit 112 processing the Nth frame 1616 of the audio stream 134 to generate the Nth set 1626 of detected keywords 180, the object determination unit 114 processing the Nth set 1626 of detected keywords 180 to generate the Nth set 1636 of objects 182, the location determination unit 170 processing the Nth frame 1646 of the video stream 136 to generate the Nth set 1656 of insertion locations 164, and the object insertion unit 116 selectively updating the Nth frame 1646 of the video stream 136 based on the Nth set 1636 of objects 182 and the Nth set 1656 of insertion locations 164 to generate the Nth frame 1646 of the sequence 1660.

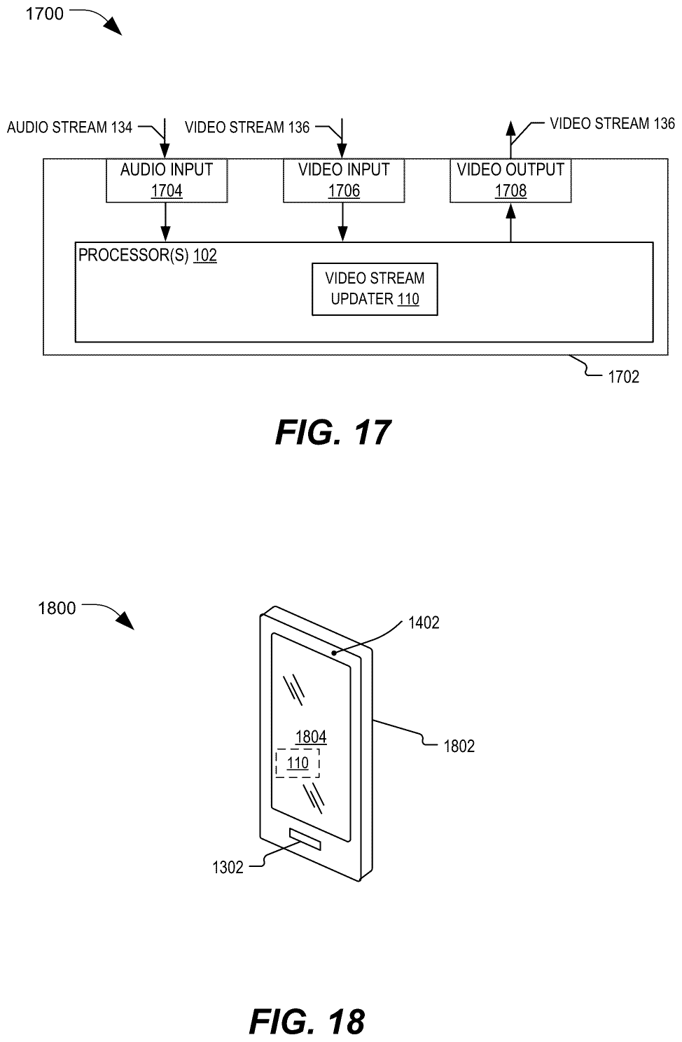

FIG. 17 depicts an implementation 1700 of the device 130 as an integrated circuit 1702 that includes the one or more processors 102. The one or more processors 102 include the video stream updater 110. The integrated circuit 1702 also includes an audio input 1704, such as one or more bus interfaces, to enable the audio stream 134 to be received for processing. The integrated circuit 1702 includes a video input 1706, such as one or more bus interfaces, to enable the video stream 136 to be received for processing. The integrated circuit 1702 includes a video output 1708, such as a bus interface, to enable sending of an output signal, such as the video stream 136 (e.g., subsequent to insertion of the one or more objects 182 of FIG. 1). The integrated circuit 1702 enables implementation of keyword-based object insertion into a video stream as a component in a system, such as a mobile phone or tablet as depicted in FIG. 18, a headset as depicted in FIG. 19, a wearable electronic device as depicted in FIG. 20, a voice-controlled speaker system as depicted in FIG. 21, a camera as depicted in FIG. 22, an XR headset as depicted in FIG. 23, XR glasses as depicted in FIG. 24, or a vehicle as depicted in FIG. 25 or FIG. 26.

FIG. 18 depicts an implementation 1800 in which the device 130 includes a mobile device 1802, such as a phone or tablet, as illustrative, non-limiting examples. The mobile device 1802 includes the one or more microphones 1302, the one or more cameras 1402, and a display screen 1804. Components of the one or more processors 102, including the video stream updater 110, are integrated in the mobile device 1802 and are illustrated using dashed lines to indicate internal components that are not generally visible to a user of the mobile device 1802. In a particular example, the video stream updater 110 operates to detect user voice activity in the audio stream 134, which is then processed to perform one or more operations at the mobile device 1802, such as to insert one or more objects 182 of FIG. 1 in the video stream 136 and to launch a graphical user interface or otherwise display the video stream 136 (e.g., with the inserted objects 182) at the display screen 1804 (e.g., via an integrated “smart assistant” application).

FIG. 19 depicts an implementation 1900 in which the device 130 includes a headset device 1902. The headset device 1902 includes the one or more microphones 1302, the one or more cameras 1402, or a combination thereof. Components of the one or more processors 102, including the video stream updater 110, are integrated in the headset device 1902. In a particular example, the video stream updater 110 operates to detect user voice activity in the audio stream 134 which is then processed to perform one or more operations at the headset device 1902, such as to insert one or more objects 182 of FIG. 1 in the video stream 136 and to transmit video data corresponding to the video stream 136 (e.g., with the inserted objects 182) to a second device (not shown), such as the one or more display devices 1114 of FIG. 11, for display.

FIG. 20 depicts an implementation 2000 in which the device 130 includes a wearable electronic device 2002, illustrated as a “smart watch.” The video stream updater 110, the one or more microphones 1302, the one or more cameras 1402, or a combination thereof, are integrated into the wearable electronic device 2002. In a particular example, the video stream updater 110 operates to detect user voice activity in an audio stream 134, which is then processed to perform one or more operations at the wearable electronic device 2002, such as to insert one or more objects 182 of FIG. 1 in a video stream 136 and to launch a graphical user interface or otherwise display the video stream 136 (e.g., with the inserted objects 182) at a display screen 2004 of the wearable electronic device 2002. To illustrate, the wearable electronic device 2002 may include a display screen that is configured to display a notification based on user speech detected by the wearable electronic device 2002. In a particular example, the wearable electronic device 2002 includes a haptic device that provides a haptic notification (e.g., vibrates) in response to detection of user voice activity. For example, the haptic notification can cause a user to look at the wearable electronic device 2002 to see a displayed notification (e.g., an object 182 inserted in a video stream 136) corresponding to a detected keyword 180 spoken by the user. The wearable electronic device 2002 can thus alert a user with a hearing impairment or a user wearing a headset that the user's voice activity is detected.

FIG. 21 is an implementation 2100 in which the device 130 includes a wireless speaker and voice activated device 2102. The wireless speaker and voice activated device 2102 can have wireless network connectivity and is configured to execute an assistant operation. The one or more processors 102 including the video stream updater 110, the one or more microphones 1302, the one or more cameras 1402, or a combination thereof, are included in the wireless speaker and voice activated device 2102. The wireless speaker and voice activated device 2102 also includes a speaker 2104. During operation, in response to receiving a verbal command (e.g., the one or more detected keywords 180) identified in an audio stream 134 via operation of the video stream updater 110, the wireless speaker and voice activated device 2102 can execute assistant operations, such as inserting the one or more objects 182 in a video stream 136 and providing the video stream 136 (e.g., with the inserted objects 182) to another device, such as the one or more display devices 1114 of FIG. 11. For example, the wireless speaker and voice activated device 2102 performs assistant operations, such as displaying an image associated with a restaurant, responsive to receiving the one or more detected keywords 180 (e.g., “I'm hungry”) after a key phrase (e.g., “hello assistant”).

FIG. 22 depicts an implementation 2200 in which the device 130 includes a portable electronic device that corresponds to a camera device 2202. The video stream updater 110, the one or more microphones 1302, or a combination thereof, are included in the camera device 2202. In a particular aspect, the one or more cameras 1402 of FIG. 14 include the camera device 2202. During operation, in response to receiving a verbal command (e.g., the one or more detected keywords 180) identified in an audio stream 134 via operation of the video stream updater 110, the camera device 2202 can execute operations responsive to spoken user commands, such as to insert one or more objects 182 in a video stream 136 captured by the camera device 2202 and to display the video stream 136 (e.g., with the inserted objects 182) at the one or more display devices 1114 of the FIG. 11. In some aspects, the one or more display devices 1114 can include a display screen of the camera device 2202, another device, or both.

FIG. 23 depicts an implementation 2300 in which the device 130 includes a portable electronic device that corresponds to an XR headset 2302. The XR headset 2302 can include a virtual reality, a mixed reality, or an augmented reality headset. The video stream updater 110, the one or more microphones 1302, the one or more cameras 1402, or a combination thereof, are integrated into the XR headset 2302. In a particular aspect, user voice activity detection can be performed on an audio stream 134 received from the one or more microphones 1302 of the XR headset 2302. A visual interface device is positioned in front of the user's eyes to enable display of augmented reality, mixed reality, or virtual reality images or scenes to the user while the XR headset 2302 is worn. In a particular example, the video stream updater 110 inserts one or more objects 182 in a video stream 136 and the visual interface device is configured to display the video stream 136 (e.g., with the inserted objects 182). In a particular aspect, the video stream updater 110 provides the video stream 136 (e.g., with the inserted objects 182) to a shared environment that is displayed by the XR headset 2302, one or more additional XR devices, or a combination thereof.

FIG. 24 depicts an implementation 2400 in which the device 130 includes a portable electronic device that corresponds to XR glasses 2402. The XR glasses 2402 can include virtual reality, augmented reality, or mixed reality glasses. The XR glasses 2402 include a holographic projection unit 2404 configured to project visual data onto a surface of a lens 2406 or to reflect the visual data off of a surface of the lens 2406 and onto the wearer's retina. The video stream updater 110, the one or more microphones 1302, the one or more cameras 1402, or a combination thereof, are integrated into the XR glasses 2402. The video stream updater 110 may function to insert one or more objects 182 in a video stream 136 based on one or more detected keywords 180 detected in an audio stream 134 received from the one or more microphones 1302. In a particular example, the holographic projection unit 2404 is configured to display the video stream 136 (e.g., with the inserted objects 182). In a particular aspect, the video stream updater 110 provides the video stream 136 (e.g., with the inserted objects 182) to a shared environment that is displayed by the holographic projection unit 2404, one or more additional XR devices, or a combination thereof.

In a particular example, the holographic projection unit 2404 is configured to display one or more of the inserted objects 182 indicating a detected audio event. For example, one or more objects 182 can be superimposed on the user's field of view at a particular position that coincides with the location of the source of the sound associated with the audio event detected in the audio stream 134. To illustrate, the sound may be perceived by the user as emanating from the direction of the one or more objects 182. In an illustrative implementation, the holographic projection unit 2404 is configured to display one or more objects 182 associated with a detected audio event (e.g., the one or more detected keywords 180).

FIG. 25 depicts an implementation 2500 in which the device 130 corresponds to, or is integrated within, a vehicle 2502, illustrated as a manned or unmanned aerial device (e.g., a package delivery drone). The video stream updater 110, the one or more microphones 1302, the one or more cameras 1402, or a combination thereof, are integrated into the vehicle 2502. User voice activity detection can be performed based on an audio stream 134 received from the one or more microphones 1302 of the vehicle 2502, such as for delivery instructions from an authorized user of the vehicle 2502. In a particular aspect, the video stream updater 110 updates a video stream 136 (e.g., assembly instructions) with one or more objects 182 based on one or more detected keywords 180 detected in an audio stream 134 and provides the video stream 136 (e.g., with the inserted objects 182) to the one or more display devices 1114 of FIG. 11. The one or more display devices 1114 can include a display screen of the vehicle 2502, a user device, or both.

FIG. 26 depicts another implementation 2600 in which the device 130 corresponds to, or is integrated within, a vehicle 2602, illustrated as a car. The vehicle 2602 includes the one or more processors 102 including the video stream updater 110. The vehicle 2602 also includes the one or more microphones 1302, the one or more cameras 1402, or a combination thereof.

In some examples, the one or more microphones 1302 are positioned to capture utterances of an operator of the vehicle 2602. User voice activity detection can be performed based on an audio stream 134 received from the one or more microphones 1302 of the vehicle 2602. In some implementations, user voice activity detection can be performed based on an audio stream 134 received from interior microphones (e.g., the one or more microphones 1302), such as for a voice command from an authorized passenger. For example, the user voice activity detection can be used to detect a voice command from an operator of the vehicle 2602 (e.g., from a parent requesting a location of a sushi restaurant) and to disregard the voice of another passenger (e.g., a child requesting a location of an ice-cream store).

In a particular implementation, the video stream updater 110, in response to determining one or more detected keywords 180 in an audio stream 134, inserts one or more objects 182 in a video stream 136 and provides the video stream 136 (e.g., with the inserted objects 182) to a display 2620. In a particular aspect, the audio stream 134 includes speech (e.g., “Sushi is my favorite”) of a passenger of the vehicle 2602. The video stream updater 110 determines the one or more detected keywords 180 (e.g., “Sushi”) based on the audio stream 134 and determines, at a first time, a first location of the vehicle 2602 based on global positioning system (GPS) data.

The video stream updater 110 determines one or more objects 182 corresponding to the one or more detected keywords 180, as described with reference to FIG. 1. Optionally, in some aspects, the video stream updater 110 uses the adaptive classifier 144 to adaptively classify the one or more objects 182 associated with the one or more detected keywords 180 and the first location. For example, the video stream updater 110, in response to determining that the set of objects 122 includes an object 122A (e.g., a sushi restaurant image) associated with one or more keywords 120A (e.g., “sushi,” “restaurant”) that match the one or more detected keywords 180 (e.g., “Sushi”) and associated with a particular location that is within a threshold distance of the first location, adds the object 122A in the one or more objects 182 (e.g., without classifying the one or more objects 182).

In a particular aspect, the video stream updater 110, in response to determining that the set of objects 122 does not include any object that is associated with the one or more detected keywords 180 and with a location that is within the threshold distance of the first location, uses the adaptive classifier 144 to classify the one or more objects 182. In a particular aspect, classifying the one or more objects 182 includes using the object generation neural network 140 to determine the one or more objects 182 associated with the one or more detected keywords 180 and the first location. For example, the video stream updater 110 retrieves, from a navigation database, an address of a restaurant that is within a threshold distance of the first location, and applies the object generation neural network 140 to the address and the one or more detected keywords 180 (e.g., “sushi”) to generate an object 122A (e.g., clip art indicating a sushi roll and the address) and adds the object 122A to the one or more objects 182.

In a particular aspect, classifying the one or more objects 182 includes using the object classification neural network 142 to determine the one or more objects 182 associated with the one or more detected keywords 180 and the first location. For example, the video stream updater 110 uses the object classification neural network 142 to process an object 122A (e.g., an image indicating a sushi roll and an address) to determine that the object 122A is associated with the keyword 120A (e.g., “sushi”) and the address. The video stream updater 110, in response to determining that the keyword 120A (e.g., “sushi”) matches the one or more detected keywords 180 and that the address is within a threshold distance of the first location, adds the object 122A to the one or more objects 182.

The video stream updater 110 inserts the one or more objects 182 in a video stream 136, and provides the video stream 136 (e.g., with the inserted objects 182) to the display 2620. For example, the inserted objects 182 are overlaid on navigation information shown in the display 2620. In a particular aspect, the video stream updater 110 determines, at a second time, a second location of the vehicle 2602 based on GPS data. In a particular implementation, the video stream updater 110 dynamically updates the video stream 136 based on a change in location of the vehicle 2602. The video stream updater 110 uses the adaptive classifier 144 to classify one or more second objects associated with one or more detected keywords 180 and the second location, and inserts the one or more second objects in the video stream 136.

In a particular aspect, a fleet of vehicles includes the vehicle 2602 and one or more additional vehicles, and the video stream updater 110 provides the video stream 136 (e.g., with the inserted objects 182) to display devices of one or more vehicles of the fleet.

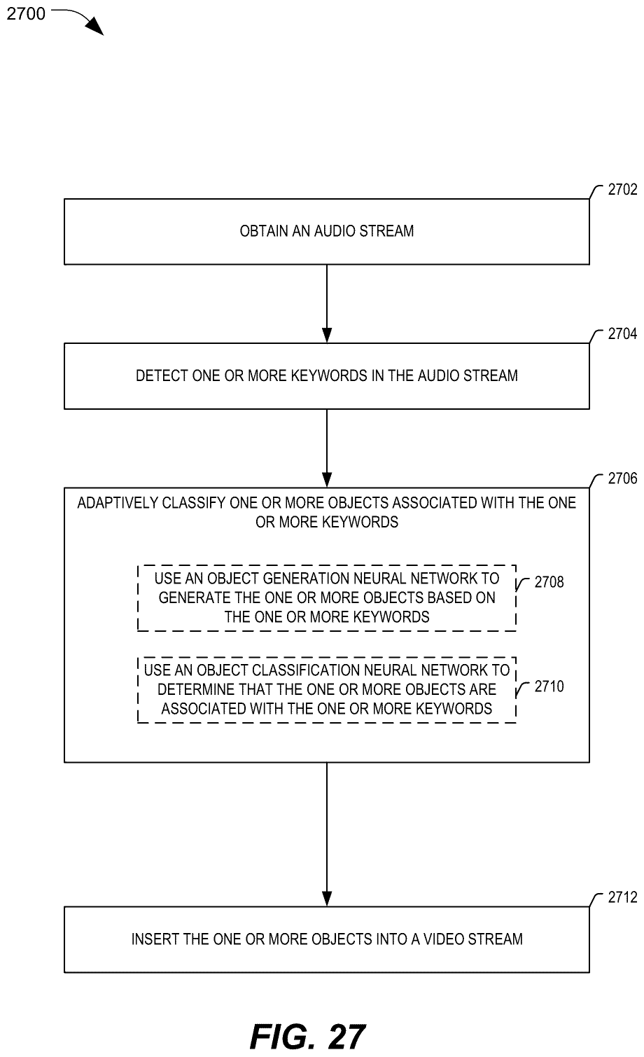

Referring to FIG. 27, a particular implementation of a method 2700 of keyword-based object insertion into a video stream is shown. In a particular aspect, one or more operations of the method 2700 are performed by at least one of the keyword detection unit 112, the object determination unit 114, the adaptive classifier 144, the object insertion unit 116, the video stream updater 110, the one or more processors 102, the device 130, the system 100 of FIG. 1, or a combination thereof.

The method 2700 includes obtaining an audio stream, at 2702. For example, the keyword detection unit 112 of FIG. 1 obtains the audio stream 134, as described with reference to FIG. 1.

The method 2700 also includes detecting one or more keywords in the audio stream, at 2704. For example, the keyword detection unit 112 of FIG. 1 detects the one or more detected keywords 180 in the audio stream 134, as described with reference to FIG. 1.

The method 2700 further includes adaptively classifying one or more objects associated with the one or more keywords, at 2706. For example, the adaptive classifier 144 of FIG. 1, in response to determining that none of a set of objects 122 stored in the database 150 are associated with the one or more detected keywords 180, may classify (e.g., to identify via neural network-based classification, to generate, or both) the one or more objects 182 associated with the one or more detected keywords 180. Alternatively, the adaptive classifier 144 of FIG. 1, in response to determining that at least one of the set of objects 122 is associated with at least one of the one or more detected keywords 180, may designate the at least one of the set of objects 122 (e.g., without classifying the one or more objects 182) as the one or more objects 182 associated with the one or more detected keywords 180.

Optionally, in some implementations, adaptively classifying, at 2706, includes using an object generation neural network to generate the one or more objects based on the one or more keywords, at 2708. For example, the adaptive classifier 144 of FIG. 1 uses the object generation neural network 140 to generate at least one of the one or more objects 182 based on the one or more detected keywords 180, as described with reference to FIG. 1.

Optionally, in some implementations, adaptively classifying, at 2706, includes using an object classification neural network to determine that the one or more objects are associated with the one or more detected keywords 180, at 2710. For example, the adaptive classifier 144 of FIG. 1 uses the object classification neural network 142 to determine that at least one of the objects 122 is associated with the one or more detected keywords 180, and adds the at least one of the objects 122 to the one or more objects 182, as described with reference to FIG. 1.

The method 2700 includes inserting the one or more objects into a video stream, at 2712. For example, the object insertion unit 116 of FIG. 1 inserts the one or more objects 182 in the video stream 136, as described with reference to FIG. 1.

The method 2700 thus enables enhancement of the video stream 136 with the one or more objects 182 that are associated with the one or more detected keywords 180. Enhancements to the video stream 136 can improve audience retention, create advertising opportunities, etc. For example, adding objects to the video stream 136 can make the video stream 136 more interesting to the audience. To illustrate, adding an object 122A (e.g., image of the Statue of Liberty) can increase audience retention for the video stream 136 when the audio stream 134 includes one or more detected keywords 180 (e.g., “New York City”) that are associated with the object 122A. In another example, an object 122A can correspond to a visual element representing a related entity (e.g., an image associated with a restaurant in New York, a restaurant serving food that is associated with New York, another business selling New York related goods or services, a travel website, or a combination thereof) that is associated with the one or more detected keywords 180.

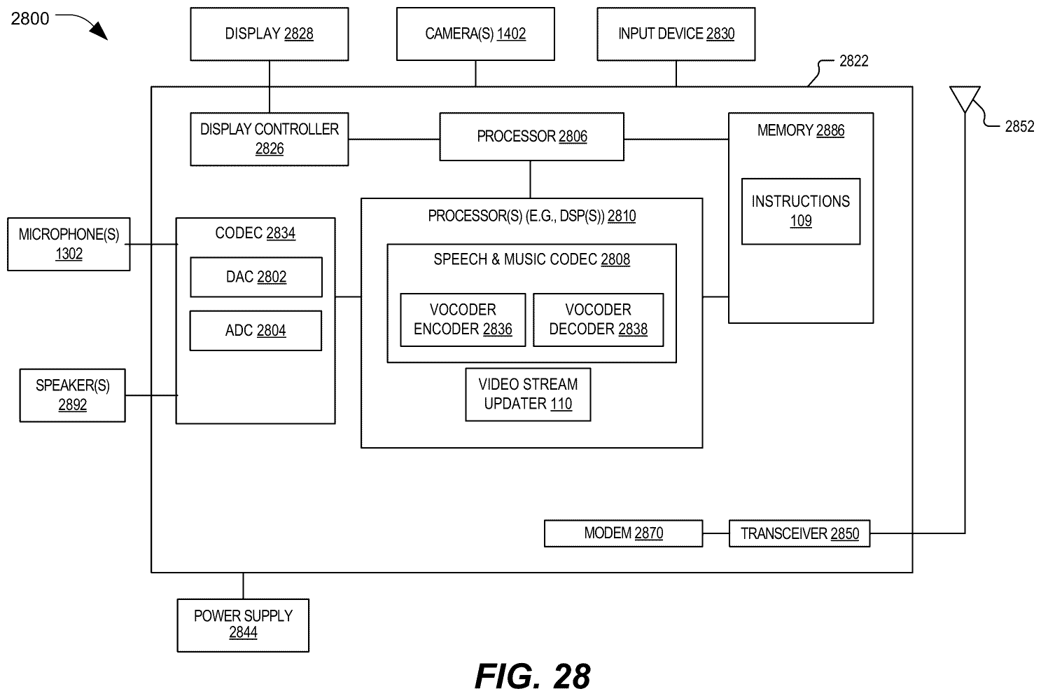

The method 2700 of FIG. 27 may be implemented by a field-programmable gate array (FPGA) device, an application-specific integrated circuit (ASIC), a processing unit such as a central processing unit (CPU), a digital signal processor (DSP), a graphics processing unit (GPU), s neural processing unit (NPU), a controller, another hardware device, firmware device, or any combination thereof. As an example, the method 2700 of FIG. 27 may be performed by a processor that executes instructions, such as described with reference to FIG. 28.

Referring to FIG. 28, a block diagram of a particular illustrative implementation of a device is depicted and generally designated 2800. In various implementations, the device 2800 may have more or fewer components than illustrated in FIG. 28. In an illustrative implementation, the device 2800 may correspond to the device 130. In an illustrative implementation, the device 2800 may perform one or more operations described with reference to FIGS. 1-27.

In a particular implementation, the device 2800 includes a processor 2806 (e.g., a CPU). The device 2800 may include one or more additional processors 2810 (e.g., one or more DSPs). In a particular aspect, the one or more processors 102 of FIG. 1 corresponds to the processor 2806, the processors 2810, or a combination thereof. The processors 2810 may include a speech and music coder-decoder (CODEC) 2808 that includes a voice coder (“vocoder”) encoder 2836, a vocoder decoder 2838, the video stream updater 110, or a combination thereof.

The device 2800 may include a memory 2886 and a CODEC 2834. The memory 2886 may include the instructions 109, that are executable by the one or more additional processors 2810 (or the processor 2806) to implement the functionality described with reference to the video stream updater 110. The device 2800 may include the modem 2870 coupled, via a transceiver 2850, to an antenna 2852.

In a particular aspect, the modem 2870 is configured to receive data and to transmit data from one or more devices. For example, the modem 2870 is configured to receive the media stream 1164 of FIG. 11 from the device 1130 and to provide the media stream 1164 to the demux 1172. In a particular example, the modem 2870 is configured to receive the video stream 136 from the video stream updater 110 and to provide the video stream 136 to the one or more display devices 1114 of FIG. 11. In another example, the modem 2870 is configured to receive the encoded data 1262 of FIG. 12 from the device 1206 and to provide the encoded data 1262 to the decoder 1270. In some implementations, the modem 2870 is configured to receive the audio stream 134 from the one or more microphones 1302 of FIG. 13, to receive the video stream 136 from the one or more cameras 1402, or a combination thereof.

The device 2800 may include a display 2828 coupled to a display controller 2826. In a particular aspect, the one or more display devices 1114 of FIG. 1 include the display 2828. One or more speakers 2892, the one or more microphones 1302, or a combination thereof may be coupled to the CODEC 2834. The CODEC 2834 may include a digital-to-analog converter (DAC) 2802, an analog-to-digital converter (ADC) 2804, or both. In a particular implementation, the CODEC 2834 may receive analog signals from the one or more microphones 1302, convert the analog signals to digital signals using the analog-to-digital converter 2804, and provide the digital signals (e.g., as the audio stream 134) to the speech and music codec 2808. The speech and music codec 2808 may process the digital signals, and the digital signals may further be processed by the video stream updater 110. In a particular implementation, the speech and music codec 2808 may provide digital signals to the CODEC 2834. The CODEC 2834 may convert the digital signals to analog signals using the digital-to-analog converter 2802 and may provide the analog signals to the one or more speakers 2892.

In a particular implementation, the device 2800 may be included in a system-in-package or system-on-chip device 2822. In a particular implementation, the memory 2886, the processor 2806, the processors 2810, the display controller 2826, the CODEC 2834, and the modem 2870 are included in the system-in-package or system-on-chip device 2822. In a particular implementation, an input device 2830, the one or more cameras 1402, and a power supply 2844 are coupled to the system-in-package or the system-on-chip device 2822. Moreover, in a particular implementation, as illustrated in FIG. 28, the display 2828, the input device 2830, the one or more cameras 1402, the one or more speakers 2892, the one or more microphones 1302, the antenna 2852, and the power supply 2844 are external to the system-in-package or the system-on-chip device 2822. In a particular implementation, each of the display 2828, the input device 2830, the one or more cameras 1402, the one or more speakers 2892, the one or more microphones 1302, the antenna 2852, and the power supply 2844 may be coupled to a component of the system-in-package or the system-on-chip device 2822, such as an interface or a controller.

The device 2800 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a playback device, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, an extended reality (XR) device, a base station, a mobile device, or any combination thereof.

In conjunction with the described implementations, an apparatus includes means for obtaining an audio stream. For example, the means for obtaining can correspond to the keyword detection unit 112, the video stream updater 110, the one or more processors 102, the device 130, the system 100 of FIG. 1, the speech recognition neural network 460 of FIG. 4, the demux 1172 of FIG. 11, the decoder 1270 of FIG. 12, the buffer 1560, the first stage 1540, the always-on power domain 1503, the second stage 1550, the second power domain 1505 of FIG. 15, the integrated circuit 1702, the audio input 1704 of FIG. 17, the mobile device 1802 of FIG. 18, the headset device 1902 of FIG. 19, the wearable electronic device 2002 of FIG. 20, the voice activated device 2102 of FIG. 21, the camera device 2202 of FIG. 22, the XR headset 2302 of FIG. 23, the XR glasses 2402 of FIG. 24, the vehicle 2502 of FIG. 25, the vehicle 2602 of FIG. 26, the CODEC 2834, the ADC 2804, the speech and music codec 2808, the vocoder decoder 2838, the processors 2810, the processor 2806, the device 2800 of FIG. 28, one or more other circuits or components configured to obtain an audio stream, or any combination thereof.

The apparatus also includes means for detecting one or more keywords in the audio stream. For example, the mean for detecting can correspond to the keyword detection unit 112, the video stream updater 110, the one or more processors 102, the device 130, the system 100 of FIG. 1, the speech recognition neural network 460, the potential keyword detector 462, the keyword selector 464 of FIG. 4, the first stage 1540, the always-on power domain 1503, the second stage 1550, the second power domain 1505 of FIG. 15, the integrated circuit 1702 of FIG. 17, the mobile device 1802 of FIG. 18, the headset device 1902 of FIG. 19, the wearable electronic device 2002 of FIG. 20, the voice activated device 2102 of FIG. 21, the camera device 2202 of FIG. 22, the XR headset 2302 of FIG. 23, the XR glasses 2402 of FIG. 24, the vehicle 2502 of FIG. 25, the vehicle 2602 of FIG. 26, the processors 2810, the processor 2806, the device 2800 of FIG. 28, one or more other circuits or components configured to detect one or more keywords, or any combination thereof.

The apparatus further includes means for adaptively classifying one or more objects associated with the one or more keywords. For example, the mean for adaptively classifying can correspond to the object determination unit 114, the adaptive classifier 144, the object generation neural network 140, the object classification neural network 142, the video stream updater 110, the one or more processors 102, the device 130, the system 100 of FIG. 1, the second stage 1550, the second power domain 1505 of FIG. 15, the integrated circuit 1702 of FIG. 17, the mobile device 1802 of FIG. 18, the headset device 1902 of FIG. 19, the wearable electronic device 2002 of FIG. 20, the voice activated device 2102 of FIG. 21, the camera device 2202 of FIG. 22, the XR headset 2302 of FIG. 23, the XR glasses 2402 of FIG. 24, the vehicle 2502 of FIG. 25, the vehicle 2602 of FIG. 26, the processors 2810, the processor 2806, the device 2800 of FIG. 28, one or more other circuits or components configured to adaptively classify, or any combination thereof.

The apparatus also includes means for inserting the one or more objects into a video stream. For example, the mean for inserting can correspond to the object insertion unit 116, the video stream updater 110, the one or more processors 102, the device 130, the system 100 of FIG. 1, the second stage 1550, the second power domain 1505 of FIG. 15, the integrated circuit 1702 of FIG. 17, the mobile device 1802 of FIG. 18, the headset device 1902 of FIG. 19, the wearable electronic device 2002 of FIG. 20, the voice activated device 2102 of FIG. 21, the camera device 2202 of FIG. 22, the XR headset 2302 of FIG. 23, the XR glasses 2402 of FIG. 24, the vehicle 2502 of FIG. 25, the vehicle 2602 of FIG. 26, the processors 2810, the processor 2806, the device 2800 of FIG. 28, one or more other circuits or components configured to selectively insert one or more objects in a video stream, or any combination thereof.

In some implementations, a non-transitory computer-readable medium (e.g., a computer-readable storage device, such as the memory 2886) includes instructions (e.g., the instructions 109) that, when executed by one or more processors (e.g., the one or more processors 2810 or the processor 2806), cause the one or more processors to obtain an audio stream (e.g., the audio stream 134) and to detect one or more keywords (e.g., the one or more detected keywords 180) in the audio stream. The instructions, when executed by the one or more processors, also cause the one or more processors to adaptively classify one or more objects (e.g., the one or more objects 182) associated with the one or more keywords. The instructions, when executed by the one or more processors, further cause the one or more processors to insert the one or more objects into a video stream (e.g., the video stream 136).

Particular aspects of the disclosure are described below in sets of interrelated Examples:

According to Example 1, a device includes: one or more processors configured to: obtain an audio stream; detect one or more keywords in the audio stream; adaptively classify one or more objects associated with the one or more keywords; and insert the one or more objects into a video stream.

Example 2 includes the device of Example 1, wherein the one or more processors are configured to, based on determining that none of a set of objects are indicated as associated with the one or more keywords, classify the one or more objects associated with the one or more keywords.

Example 3 includes the device of Example 1 or Example 2, wherein classifying the one or more objects includes using an object generation neural network to generate the one or more objects based on the one or more keywords.

Example 4 includes the device of Example 3, wherein the object generation neural network includes stacked generative adversarial networks (GANs).

Example 5 includes the device of any of Example 1 to Example 4, wherein classifying the one or more objects includes using an object classification neural network to determine that the one or more objects are associated with the one or more keywords.

Example 6 includes the device of Example 5, wherein the object classification neural network includes a convolutional neural network (CNN).

Example 7 includes the device of any of Example 1 to Example 6, wherein the one or more processors are configured to apply a keyword detection neural network to the audio stream to detect the one or more keywords.

Example 8 includes the device of Example 7, wherein the keyword detection neural network includes a recurrent neural network (RNN).

Example 9 includes the device of any of Example 1 to Example 8, wherein the one or more processors are configured to: apply a location neural network to the video stream to determine one or more insertion locations in one or more video frames of the video stream; and insert the one or more objects at the one or more insertion locations in the one or more video frames.

Example 10 includes the device of Example 9, wherein the location neural network includes a residual neural network (resnet).

Example 11 includes the device of any of Example 1 to Example 10, wherein the one or more processors are configured to, based at least on a file type of a particular object of the one or more objects, insert the particular object in a foreground or a background of the video stream.

Example 12 includes the device of any of Example 1 to Example 11, wherein the one or more processors are configured to, in response to a determination that a background of the video stream includes at least one object associated with the one or more keywords, insert the one or more objects into a foreground of the video stream.

Example 13 includes the device of any of Example 1 to Example 12, wherein the one or more processors are configured to perform round-robin insertion of the one or more objects in the video stream.

Example 14 includes the device of any of Example 1 to Example 13, wherein the one or more processors are integrated into at least one of a mobile device, a vehicle, an augmented reality device, a communication device, a playback device, a television, or a computer.

Example 15 includes the device of any of Example 1 to Example 14, wherein the audio stream and the video stream are included in a live media stream that is received at the one or more processors.

Example 16 includes the device of Example 15, wherein the one or more processors are configured to receive the live media stream from a network device.

Example 17 includes the device of Example 16, further including a modem, wherein the one or more processors are configured to receive the live media stream via the modem.

Example 18 includes the device of any of Example 1 to Example 17, further including one or more microphones, wherein the one or more processors are configured to receive the audio stream from the one or more microphones.

Example 19 includes the device of any of Example 1 to Example 18, further including a display device, wherein the one or more processors are configured to provide the video stream to the display device.

Example 20 includes the device of any of Example 1 to Example 19, further including one or more speakers, wherein the one or more processors are configured to output the audio stream via the one or more speakers.

Example 21 includes the device of any of Example 1 to Example 20, wherein the one or more processors are integrated in a vehicle, wherein the audio stream includes speech of a passenger of the vehicle, and wherein the one or more processors are configured to provide the video stream to a display device of the vehicle.

Example 22 includes the device of Example 21, wherein the one or more processors are configured to: determine, at a first time, a first location of the vehicle; and adaptively classify the one or more objects associated with the one or more keywords and the first location.

Example 23 includes the device of Example 22, wherein the one or more processors are configured to: determine, at a second time, a second location of the vehicle; adaptively classify one or more second objects associated with the one or more keywords and the second location; and insert the one or more second objects into the video stream.

Example 24 includes the device of any of Example 21 to Example 23, wherein the one or more processors are configured to send the video stream to display devices of one or more second vehicles.

Example 25 includes the device of any of Example 1 to Example 24, wherein the one or more processors are integrated in an extended reality (XR) device, wherein the audio stream includes speech of a user of the XR device, and wherein the one or more processors are configured to provide the video stream to a shared environment that is displayed by at least the XR device.

Example 26 includes the device of any of Example 1 to Example 25, wherein the audio stream includes speech of a user, and wherein the one or more processors are configured to send the video stream to displays of one or more authorized devices.

According to Example 27, a method includes: obtaining an audio stream at a device; detecting, at the device, one or more keywords in the audio stream; selectively applying, at the device, a neural network to determine one or more objects associated with the one or more keywords; and inserting, at the device, the one or more objects into a video stream.

Example 28 includes the method of Example 27, further including, based on determining that none of a set of objects includes any objects that are indicated as associated with the one or more keywords, classify the one or more objects associated with the one or more keywords.

Example 29 includes the method of Example 27 or Example 28, wherein classifying the one or more objects includes using an object generation neural network to generate the one or more objects based on the one or more keywords.

Example 30 includes the method of Example 29, wherein the object generation neural network includes stacked generative adversarial networks (GANs).

Example 31 includes the method of any of Example 27 to Example 30, wherein classifying the one or more objects includes using an object classification neural network to determine that the one or more objects are associated with the one or more keywords.

Example 32 includes the method of Example 31, wherein the object classification neural network includes a convolutional neural network (CNN).

Example 33 includes the method of any of Example 27 to Example 32, further including applying a keyword detection neural network to the audio stream to detect the one or more keywords.

Example 34 includes the method of Example 33, wherein the keyword detection neural network includes a recurrent neural network (RNN).

Example 35 includes the method of any of Example 27 to Example 34, further including: applying a location neural network to the video stream to determine one or more insertion locations in one or more video frames of the video stream; and inserting the one or more objects at the one or more insertion locations in the one or more video frames.

Example 36 includes the method of Example 35, wherein the location neural network includes a residual neural network (resnet).

Example 37 includes the method of any of Example 27 to Example 36, further including, based at least on a file type of a particular object of the one or more objects, inserting the particular object in a foreground or a background of the video stream.

Example 38 includes the method of any of Example 27 to Example 37, further including, in response to a determination that a background of the video stream includes at least one object associated with the one or more keywords, inserting the one or more objects into a foreground of the video stream.

Example 39 includes the method of any of Example 27 to Example 38, further including performing round-robin insertion of the one or more objects in the video stream.

Example 40 includes the method of any of Example 27 to Example 39, wherein the device is integrated into at least one of a mobile device, a vehicle, an augmented reality device, a communication device, a playback device, a television, or a computer.

Example 41 includes the method of any of Example 27 to Example 40, wherein the audio stream and the video stream are included in a live media stream that is received at the device.

Example 42 includes the method of Example 41, further including receiving the live media stream from a network device.

Example 43 includes the method of Example 42, further including receiving the live media stream via a modem.

Example 44 includes the method of any of Example 27 to Example 43, further including receiving the audio stream from one or more microphones.

Example 45 includes the method of any of Example 27 to Example 44, further including providing the video stream to a display device.

Example 46 includes the method of any of Example 27 to Example 45, further including providing the audio stream to one or more speakers.

Example 47 includes the method of any of Example 27 to Example 46, further including providing the video stream to a display device of a vehicle, wherein the audio stream includes speech of a passenger of the vehicle.

Example 48 includes the method of Example 47, further including: determining, at a first time, a first location of the vehicle; and adaptively classifying the one or more objects associated with the one or more keywords and the first location.

Example 49 includes the method of Example 48, further including: determining, at a second time, a second location of the vehicle; adaptively classifying one or more second objects associated with the one or more keywords and the second location; and inserting the one or more second objects into the video stream.

Example 50 includes the method of any of Example 47 to Example 49, further including sending the video stream to display devices of one or more second vehicles.

Example 51 includes the method of any of Example 27 to Example 50, further including providing the video stream to a shared environment that is displayed by at least an extended reality (XR) device, wherein the audio stream includes speech of a user of the XR device.

Example 52 includes the method of any of Example 27 to Example 51, further including sending the video stream to displays of one or more authorized devices, wherein the audio stream includes speech of a user.

According to Example 53, a device includes: a memory configured to store instructions; and a processor configured to execute the instructions to perform the method of any of Example 27 to Example 52.

According to Example 54, a non-transitory computer-readable medium stores instructions that, when executed by one or more processors, cause the one or more processors to perform the method of any of Example 27 to Example 52.

According to Example 55, an apparatus includes means for carrying out the method of any of Example 27 to Example 52.

According to Example 56, a non-transitory computer-readable medium stores instructions that, when executed by one or more processors, cause the one or more processors to: obtain an audio stream; detect one or more keywords in the audio stream; adaptively classifying one or more objects associated with the one or more keywords; and insert the one or more objects into a video stream.

According to Example 57, an apparatus includes: means for obtaining an audio stream; means for detecting one or more keywords in the audio stream; means for adaptively classifying one or more objects associated with the one or more keywords; and means for inserting the one or more objects into a video stream.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A device comprising:
one or more processors configured to:
obtain an audio stream;
apply a keyword detection neural network to the audio stream to detect one or more keywords in the audio stream;
adaptively classify one or more objects associated with the one or more keywords; and
insert the one or more objects into a video stream.

2. The device of claim 1, wherein the one or more processors are configured to, based on determining that none of a set of objects are indicated as associated with the one or more keywords, classify the one or more objects associated with the one or more keywords.

3. The device of claim 1, wherein classifying the one or more objects includes using an object generation neural network to generate the one or more objects based on the one or more keywords.

4. The device of claim 3, wherein the object generation neural network includes stacked generative adversarial networks (GANs).

5. The device of claim 1, wherein classifying the one or more objects includes using an object classification neural network to determine that the one or more objects are associated with the one or more keywords.

6. The device of claim 5, wherein the object classification neural network includes a convolutional neural network (CNN).

7. (canceled)

8. The device of claim 1 wherein the keyword detection neural network includes a recurrent neural network (RNN).

9. The device of claim 1, wherein the one or more processors are configured to:
apply a location neural network to the video stream to determine one or more insertion locations in one or more video frames of the video stream; and
insert the one or more objects at the one or more insertion locations in the one or more video frames.

10. The device of claim 9, wherein the location neural network includes a residual neural network (resnet).

11. The device of claim 1, wherein the one or more processors are configured to, based at least on a file type of a particular object of the one or more objects, insert the particular object in a foreground or a background of the video stream.

12. The device of claim 1, wherein the one or more processors are configured to, in response to a determination that a background of the video stream includes at least one object associated with the one or more keywords, insert the one or more objects into a foreground of the video stream.

13. The device of claim 1, wherein the one or more processors are configured to perform round-robin insertion of the one or more objects in the video stream.

14. The device of claim 1, wherein the one or more processors are integrated into at least one of a mobile device, a vehicle, an augmented reality device, a communication device, a playback device, a television, or a computer.

15. The device of claim 1, wherein the audio stream and the video stream are included in a live media stream that is received at the one or more processors.

16. The device of claim 15, wherein the one or more processors are configured to receive the live media stream from a network device.

17. The device of claim 16, further comprising a modem, wherein the one or more processors are configured to receive the live media stream via the modem.

18. The device of claim 1, further comprising one or more microphones, wherein the one or more processors are configured to receive the audio stream from the one or more microphones.

19. The device of claim 1, further comprising a display device, wherein the one or more processors are configured to provide the video stream to the display device.

20. The device of claim 1, further comprising one or more speakers, wherein the one or more processors are configured to output the audio stream via the one or more speakers.

21. The device of claim 1, wherein the one or more processors are integrated in a vehicle, wherein the audio stream includes speech of a passenger of the vehicle, and wherein the one or more processors are configured to provide the video stream to a display device of the vehicle.

22. The device of claim 21, wherein the one or more processors are configured to:
determine, at a first time, a first location of the vehicle; and
adaptively classify the one or more objects associated with the one or more keywords and the first location.

23. The device of claim 22, wherein the one or more processors are configured to:
determine, at a second time, a second location of the vehicle;
adaptively classify one or more second objects associated with the one or more keywords and the second location; and
insert the one or more second objects into the video stream.

24. The device of claim 21, wherein the one or more processors are configured to send the video stream to display devices of one or more second vehicles.

25. The device of claim 1, wherein the one or more processors are integrated in an extended reality (XR) device, wherein the audio stream includes speech of a user of the XR device, and wherein the one or more processors are configured to provide the video stream to a shared environment that is displayed by at least the XR device.

26. The device of claim 1, wherein the audio stream includes speech of a user, and wherein the one or more processors are configured to send the video stream to displays of one or more authorized devices.

27. A method comprising:
obtaining an audio stream at a device;
detecting, at the device, one or more keywords in the audio stream;
generating, using an object generation neural network, one or more objects associated with the one or more keywords; and
inserting, at the device, the one or more objects into a video stream.

28. (canceled)

29. A non-transitory computer-readable medium storing instructions that, when executed by one or more processors, cause the one or more processors to:
obtain an audio stream;
apply a keyword detection neural network to the audio stream to detect one or more keywords in the audio stream;
adaptively classify one or more objects associated with the one or more keywords; and
insert the one or more objects into a video stream.

30. An apparatus comprising:
means for obtaining an audio stream;
means for detecting one or more keywords in the audio stream;
means for generating, using an object generation neural network, one or more objects associated with the one or more keywords; and
means for inserting the one or more objects into a video stream.

31. The method of claim 27, further comprising, based on determining that none of a set of objects are indicated as associated with the one or more keywords, generating the one or more objects associated with the one or more keywords.

32. The method of claim 27, further comprising:
applying a location neural network to the video stream to determine one or more insertion locations in one or more video frames of the video stream; and
inserting the one or more objects at the one or more insertion locations in the one or more video frames.
